(19) United States
(12) Patent Application Publication
(10) Pub. No.: US 2025/0119914 A1
(43) Pub. Date: Apr. 10, 2025

(54) PHYSICAL UPLINK CONTROL CHANNEL (PUCCH) TRANSMISSION WITH SIMULTANEOUS BEAMS

(71) Applicant: QUALCOMM Incorporated, San Diego, CA (US)

(72) Inventors: Fang YUAN, Beijing (CN); Wooseok NAM, San Diego, CA (US); Qiaoyu LI, Beijing (CN); Tao LUO, San Diego, CA (US)

(21) Appl. No.: 18/291,381

(22) PCT Filed: Sep. 24, 2021
(86) PCT No.: PCT/CN2021/120146

§ 371 Date: Jan. 23, 2024

(51) Int. Cl. H04W 72/21; H04W 72/044; H04W 72/0446; H04W 72/231

(52) U.S. Cl. CPC H04W 72/21; H04W 72/0446; H04W 72/046; H04W 72/231

(57) ABSTRACT

Various aspects of the present disclosure generally relate to wireless communication. In some aspects, a user equipment (UE) may receive a configuration for a physical uplink control channel (PUCCH) resource for a transmission that uses multiple beams in a common time domain resource. The PUCCH resource may include multiple sets of physical resource blocks (PRBs). The UE may transmit uplink control information using the multiple beams in a respective set of PRBs of the multiple sets of PRBs of the PUCCH resource. Numerous other aspects are described.

### INTRODUCTION

Aspects of the present disclosure generally relate to wireless communication and to techniques and apparatuses for physical uplink control channel (PUCCH) transmission.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving a configuration for a physical uplink control channel (PUCCH) resource for a transmission that uses multiple beams in a same time domain resource, the PUCCH resource including multiple sets of physical resource blocks (PRBs). The method may include transmitting uplink control information (UCI) using the multiple beams in a respective set of PRBs of the multiple sets of PRBs of the PUCCH resource.

Some aspects described herein relate to a method of wireless communication performed by an apparatus of a base station. The method may include transmitting a configuration for a PUCCH resource for a transmission that uses multiple beams in a same time domain resource, the PUCCH resource including multiple sets of PRBs. The method may include receiving UCI using the multiple beams in a respective set of PRBs of the multiple sets of PRBs of the PUCCH resource.

Some aspects described herein relate to a method of wireless communication performed by an apparatus of a UE. The method may include receiving a configuration for a PUCCH resource for a transmission that uses multiple beams in a same time domain resource, the PUCCH resource including a single set of PRBs. The method may include transmitting UCI using the multiple beams in the single set of PRBs of the PUCCH resource.

Some aspects described herein relate to a method of wireless communication performed by a base station. The method may include transmitting a configuration for a PUCCH resource for a transmission that uses multiple beams in a same time domain resource, the PUCCH resource including a single set of PRBs. The method may include receiving UCI using the multiple beams in the single set of PRBs of the PUCCH resource.

Some aspects described herein relate to an apparatus of a UE for wireless communication. The apparatus of the UE may include a memory and one or more processors coupled to the memory. The memory and the one or more processors may be configured to receive a configuration for a PUCCH resource for a transmission that uses multiple beams in a same time domain resource, the PUCCH resource including multiple sets of PRBs. The memory and the one or more processors may be configured to transmit UCI using the multiple beams in a respective set of PRBs of the multiple sets of PRBs of the PUCCH resource.

Some aspects described herein relate to an apparatus of a base station for wireless communication. The apparatus of the base station may include a memory and one or more processors coupled to the memory. The memory and the one or more processors may be configured to transmit a configuration for a PUCCH resource for a transmission that uses multiple beams in a same time domain resource, the PUCCH resource including multiple sets of PRBs. The memory and the one or more processors may be configured to receive UCI using the multiple beams in a respective set of PRBs of the multiple sets of PRBs of the PUCCH resource.

Some aspects described herein relate to an apparatus of a UE for wireless communication. The apparatus of the UE may include a memory and one or more processors coupled to the memory. The memory and the one or more processors may be configured to receive a configuration for a PUCCH resource for a transmission that uses multiple beams in a same time domain resource, the PUCCH resource including a single set of PRBs. The memory and the one or more processors may be configured to transmit UCI using the multiple beams in the single set of PRBs of the PUCCH resource.

Some aspects described herein relate to an apparatus of a base station for wireless communication. The apparatus of the base station may include a memory and one or more processors coupled to the memory. The memory and the one or more processors may be configured to transmit a configuration for a PUCCH resource for a transmission that uses multiple beams in a same time domain resource, the PUCCH resource including a single set of PRBs. The memory and the one or more processors may be configured to receive UCI using the multiple beams in the single set of PRBs of the PUCCH resource.

Some aspects described herein relate to a non-transitory computer-readable medium that stores a set of instructions for wireless communication by a UE. The set of instructions, when executed by one or more processors of the UE, may cause the UE to receive a configuration for a PUCCH resource for a transmission that uses multiple beams in a same time domain resource, the PUCCH resource including multiple sets of PRBs. The set of instructions, when executed by one or more processors of the UE, may cause the UE to transmit UCI using the multiple beams in a respective set of PRBs of the multiple sets of PRBs of the PUCCH resource.

Some aspects described herein relate to a non-transitory computer-readable medium that stores a set of instructions for wireless communication by a base station. The set of instructions, when executed by one or more processors of the base station, may cause the base station to transmit a configuration for a PUCCH resource for a transmission that uses multiple beams in a same time domain resource, the PUCCH resource including multiple sets of PRBs. The set of instructions, when executed by one or more processors of the base station, may cause the base station to receive UCI using the multiple beams in a respective set of PRBs of the multiple sets of PRBs of the PUCCH resource.

Some aspects described herein relate to a non-transitory computer-readable medium that stores a set of instructions for wireless communication by a UE. The set of instructions, when executed by one or more processors of the UE, may cause the UE to receive a configuration for a PUCCH resource for a transmission that uses multiple beams in a same time domain resource, the PUCCH resource including a single set of PRBs. The set of instructions, when executed by one or more processors of the UE, may cause the UE to transmit UCI using the multiple beams in the single set of PRBs of the PUCCH resource.

Some aspects described herein relate to a non-transitory computer-readable medium that stores a set of instructions for wireless communication by a base station. The set of instructions, when executed by one or more processors of the base station, may cause the base station to transmit a configuration for a PUCCH resource for a transmission that uses multiple beams in a same time domain resource, the PUCCH resource including a single set of PRBs. The set of instructions, when executed by one or more processors of the base station, may cause the base station to receive UCI using the multiple beams in the single set of PRBs of the PUCCH resource.

Some aspects described herein relate to an apparatus for wireless communication. The apparatus may include means for receiving a configuration for a PUCCH resource for a transmission that uses multiple beams in a same time domain resource, the PUCCH resource including multiple sets of PRBs. The apparatus may include means for transmitting UCI using the multiple beams in a respective set of PRBs of the multiple sets of PRBs of the PUCCH resource.

Some aspects described herein relate to an apparatus for wireless communication. The apparatus may include means for transmitting a configuration for a PUCCH resource for a transmission that uses multiple beams in a same time domain resource, the PUCCH resource including multiple sets of PRBs. The apparatus may include means for receiving UCI using the multiple beams in a respective set of PRBs of the multiple sets of PRBs of the PUCCH resource.

Some aspects described herein relate to an apparatus for wireless communication. The apparatus may include means for receiving a configuration for a PUCCH resource for a transmission that uses multiple beams in a same time domain resource, the PUCCH resource including a single set of PRBs. The apparatus may include means for transmitting UCI using the multiple beams in the single set of PRBs of the PUCCH resource.

Some aspects described herein relate to an apparatus for wireless communication. The apparatus may include means for transmitting a configuration for a PUCCH resource for a transmission that uses multiple beams in a same time domain resource, the PUCCH resource including a single set of PRBs. The apparatus may include means for receiving UCI using the multiple beams in the single set of PRBs of the PUCCH resource.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a slot format, in accordance with the present disclosure.

FIG. 4 is a diagram illustrating an example of antenna ports, in accordance with the present disclosure.

FIGS. 5A-5B are diagrams illustrating examples of using beams for communications between a base station and a UE, in accordance with the present disclosure.

FIG. 6A illustrates an example logical architecture of a distributed radio access network, in accordance with the present disclosure.

FIG. 6B is a diagram illustrating an example of an open radio access network (O-RAN) architecture, in accordance with the present disclosure.

FIG. 7 is a diagram illustrating an example of multi-transmit receive point (TRP) communication, in accordance with the present disclosure.

FIG. 8A is a diagram illustrating an example of frequency hopping within a physical uplink control channel (PUCCH) resource, in accordance with the present disclosure.

FIG. 8B is a diagram illustrating an example of uplink control information (UCI) repetition, in accordance with the present disclosure.

FIG. 8C is a diagram illustrating an example of beam hopping within a PUCCH resource, in accordance with the present disclosure.

FIG. 8D is a diagram illustrating an example of PUCCH configuration and scheduling, in accordance with the present disclosure.

FIGS. 9A-9I are diagrams illustrating one or more examples associated with PUCCH transmission with simultaneous beams, in accordance with the present disclosure.

FIG. 10 is a diagram illustrating an example associated with PUCCH transmission with simultaneous beams, in accordance with the present disclosure.

FIGS. 11-12 are diagrams illustrating example processes associated with PUCCH transmission with simultaneous beams, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example implementation of code and circuitry for an apparatus, in accordance with the present disclosure.

### DETAILED DESCRIPTION

A user equipment (UE) may perform a physical uplink control channel (PUCCH) transmission that carries various uplink control information (UCI) for the UE, such as channel state information, a scheduling request, hybrid automatic repeat request (HARQ) feedback (e.g., an acknowledgment (ACK) or negative ACK (NACK)), or the like. The UE may perform the PUCCH transmission in a PUCCH resource. A PUCCH resource configuration for the PUCCH resource may be indicated by a base station, for example, in a radio resource control (RRC) message, or the like. The PUCCH resource configuration may include information identifying a PUCCH resource identifier for the PUCCH resource, a PUCCH format (e.g., a long PUCCH format, a short PUCCH format, or the like), a starting physical resource block (PRB) of the PUCCH resource, a quantity of PRBs in the PUCCH resource, or the like.

The UCI transmitted by the UE may be used by a base station for scheduling, beam management, HARQ retransmission, power control, or the like. Accordingly, the UCI facilitates communication between the base station and the UE, and successful reception of the UCI by the base station benefits this communication. Reception of the UCI by the base station may be affected by channel conditions, spatial conditions, or the like. To account for spatial conditions and facilitate successful reception of the UCI by the base station, the UE may transmit the UCI in a PUCCH resource using different beams in different sets of symbols within the PUCCH resource.

Aspects described herein enable a PUCCH transmission using multiple beams in a common time domain resource (e.g., a starting symbol and a quantity of symbols used for the PUCCH transmission is common to the multiple beams). That is, the PUCCH transmission using multiple beams may be simultaneous (i.e., occur in the same time domain resource or in overlapping time domain resources, for example, a first transmission using a first beam may be in a first time domain resource that overlaps partially or fully with a second time domain resource for a second transmission using a second beam). In some aspects, a PUCCH resource used for the PUCCH transmission may include multiple sets of PRBs, and respective beams may be used for transmission of UCI in respective sets of PRBs. In some aspects, respective parts of the UCI may be transmitted in the respective sets of PRBs, or respective repetitions of the UCI may be transmitted in the respective sets of PRBs.

In some aspects, a PUCCH resource used for the transmission may include a single set of PRBs, and respective beams may be used for transmission of UCI in the single set of PRBs. For example, a UE may transmit the UCI in the single set of PRBs, using the multiple beams, in a single frequency network manner (e.g., at the same time and over the same frequency channel). Moreover, a UE may transmit the UCI in the single set of PRBs, using the multiple beams and using a single antenna port. For example, by using the single antenna port, a UE may transmit multiple copies of the same signal simultaneously using the multiple beams.

In this way, the simultaneous PUCCH transmission may improve a frequency diversity of the PUCCH transmission (e.g., by transmission in multiple sets of PRBs) and/or a spatial diversity of the PUCCH transmission (e.g., by transmission using multiple beams). Accordingly, a performance of the PUCCH transmission may be improved, thereby improving a timeliness of the UCI, a usefulness of the UCI, and a likelihood of successful reception of the UCI. In this way, aspects described herein enable conservation of radio resources, processing resources, and/or power resources that would otherwise be consumed if the UCI were not successfully received by the base station (e.g., due to scheduling, beam management, power control, or the like, being performed without the UCI). Moreover, using multiple beams in a common time domain resource for the PUCCH transmission facilitates conservation of time resources, improved utilization of PUCCH resources, and reduced latency associated with the UCI.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

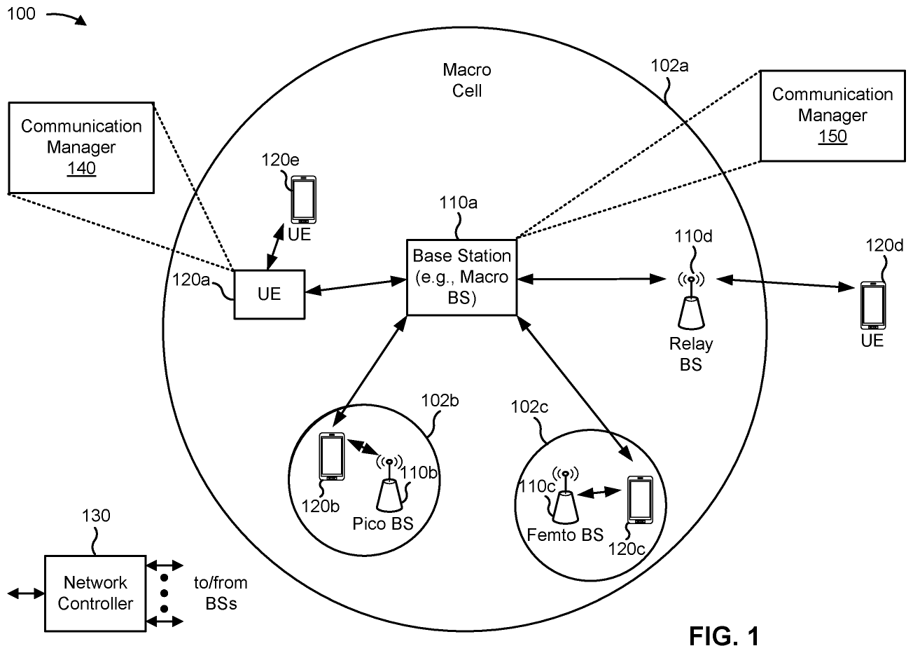

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for a PUCCH resource for a transmission using multiple beams in a common time domain resource, the PUCCH resource including a single set of PRBs or multiple sets of PRBs; and transmit UCI using the multiple beams in the single set of PRBs of the PUCCH resource or using the multiple beams respectively in the multiple sets of PRBs of the PUCCH resource. Additionally, or alternatively, the communication manager 140 may perform one or more other operations described herein.

In some aspects, the base station 110 may include a communication manager 150. As described in more detail elsewhere herein, the communication manager 150 may transmit a configuration for a PUCCH resource for a transmission using multiple beams in a common time domain resource, the PUCCH resource including a single set of PRBs or multiple sets of PRBs; and receive UCI using the multiple beams in the single set of PRBs of the PUCCH resource or using the multiple beams respectively in the multiple sets of PRBs of the PUCCH resource. Additionally, or alternatively, the communication manager 150 may perform one or more other operations described herein.

As indicated above, FIG. 1 is provided as an example. Other examples may differ from what is described with regard to FIG. 1.

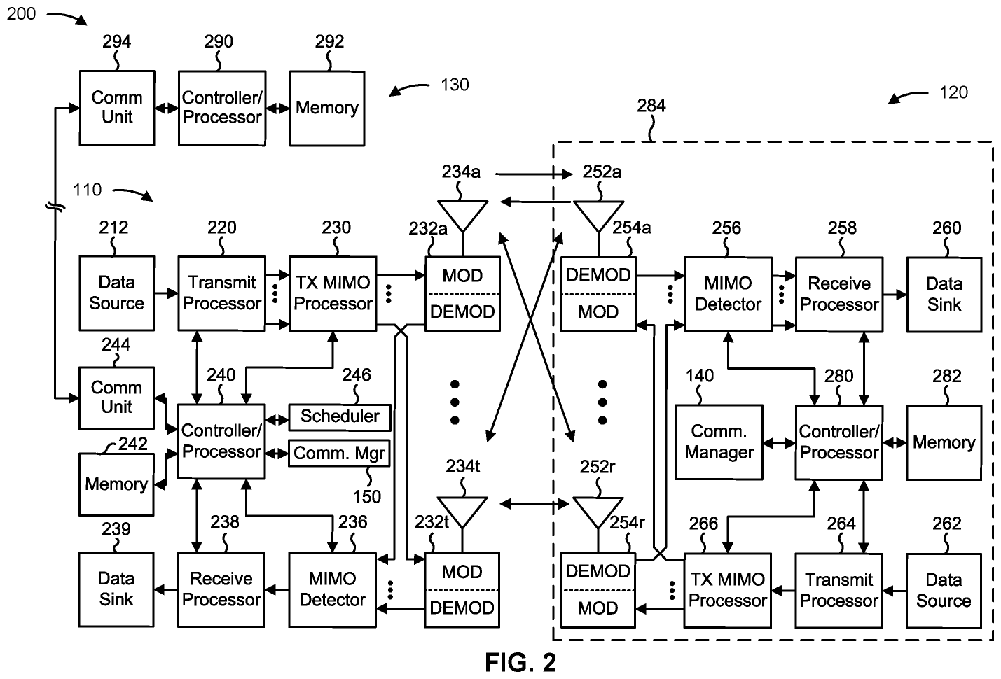

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

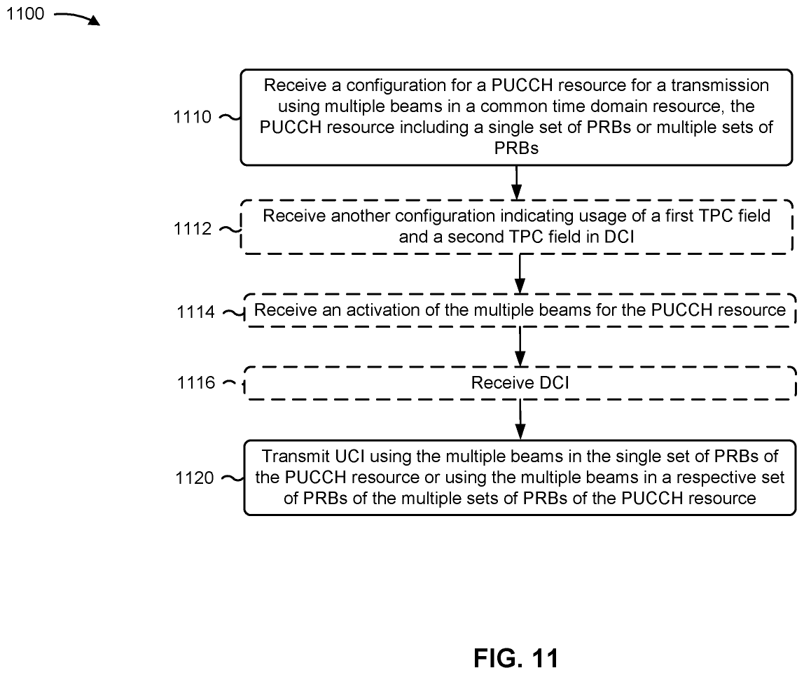

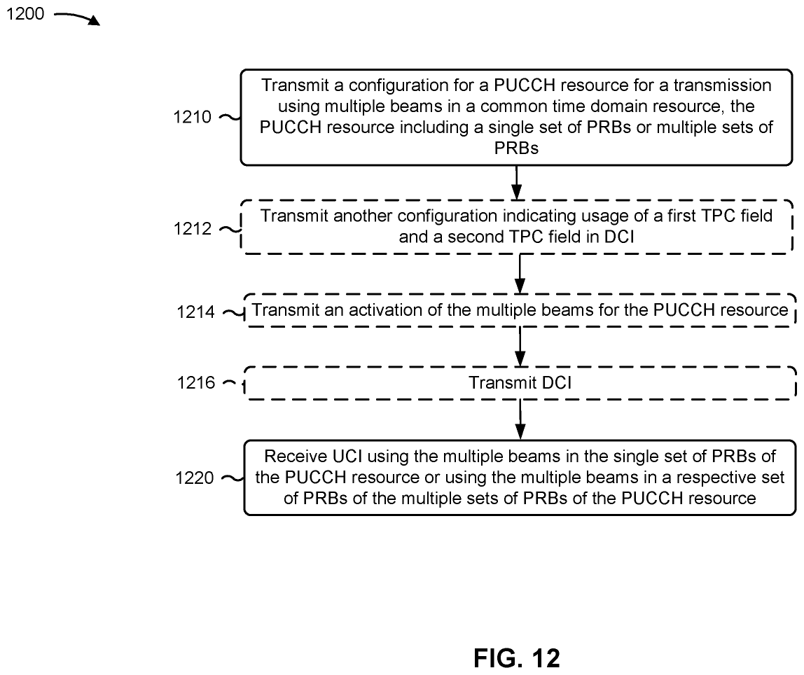

The controller/processor 240 of the base station 110, the controller/processor 280 of the UE 120, and/or any other component(s) of FIG. 2 may perform one or more techniques associated with PUCCH transmission with simultaneous beams, as described in more detail elsewhere herein. In some aspects, the TRP described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving a configuration for a PUCCH resource for a transmission using multiple beams in a common time domain resource, the PUCCH resource including a single set of PRBs or multiple sets of PRBs; and/or means for transmitting UCI using the multiple beams in the single set of PRBs of the PUCCH resource or using the multiple beams respectively in the multiple sets of PRBs of the PUCCH resource. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting a configuration for a PUCCH resource for a transmission using multiple beams in a common time domain resource, the PUCCH resource including a single set of PRBs or multiple sets of PRBs; and/or means for receiving UCI using the multiple beams in the single set of PRBs of the PUCCH resource or using the multiple beams respectively in the multiple sets of PRBs of the PUCCH resource. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

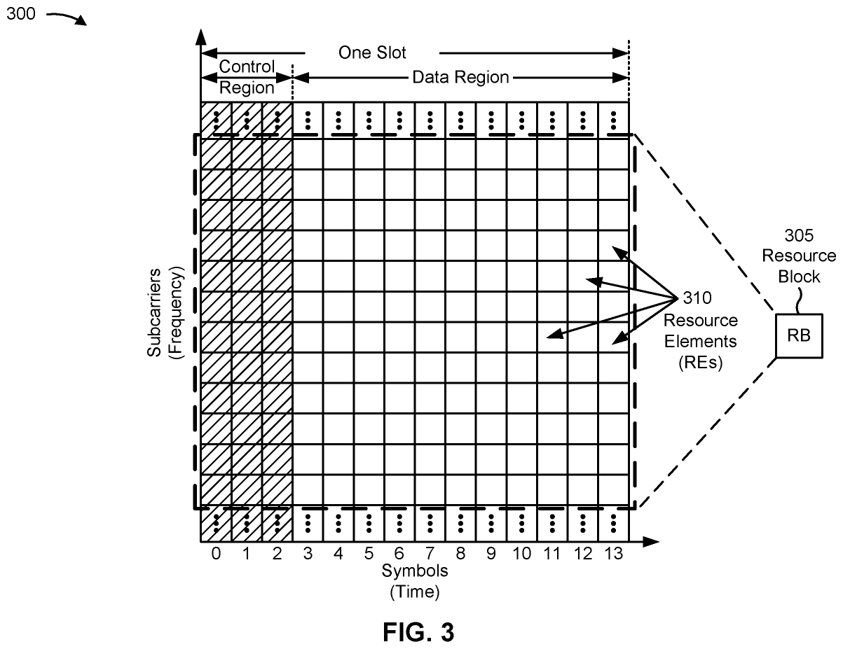

FIG. 3 is a diagram illustrating an example 300 of a slot format, in accordance with the present disclosure. As shown in FIG. 3, time-frequency resources in a radio access network (RAN) may be partitioned into resource blocks, shown by a single resource block (RB) 305. An RB 305 is sometimes referred to as a PRB. An RB 305 includes a set of subcarriers (e.g., 12 subcarriers) and a set of symbols (e.g., 14 symbols) that are schedulable by a base station 110 as a unit. In some aspects, an RB 305 may include a set of subcarriers in a single slot. As shown, a single time-frequency resource included in an RB 305 may be referred to as a resource element (RE) 310. An RE 310 may include a single subcarrier (e.g., in frequency) and a single symbol (e.g., in time). A symbol may be referred to as an orthogonal frequency division multiplexing (OFDM) symbol. An RE 310 may be used to transmit one modulated symbol, which may be a real value or a complex value.

In some telecommunication systems (e.g., NR), RBs 305 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

A PUCCH resource may include one or more RBs 305 (i.e., one or more PRBs). In some examples, a quantity of PRBs in the PUCCH resource may be configured for a UE. For example, the quantity of PRBs may be configured for a PUCCH format that is configured for the PUCCH resource.

As indicated above, FIG. 3 is provided as an example. Other examples may differ from what is described with respect to FIG. 3.

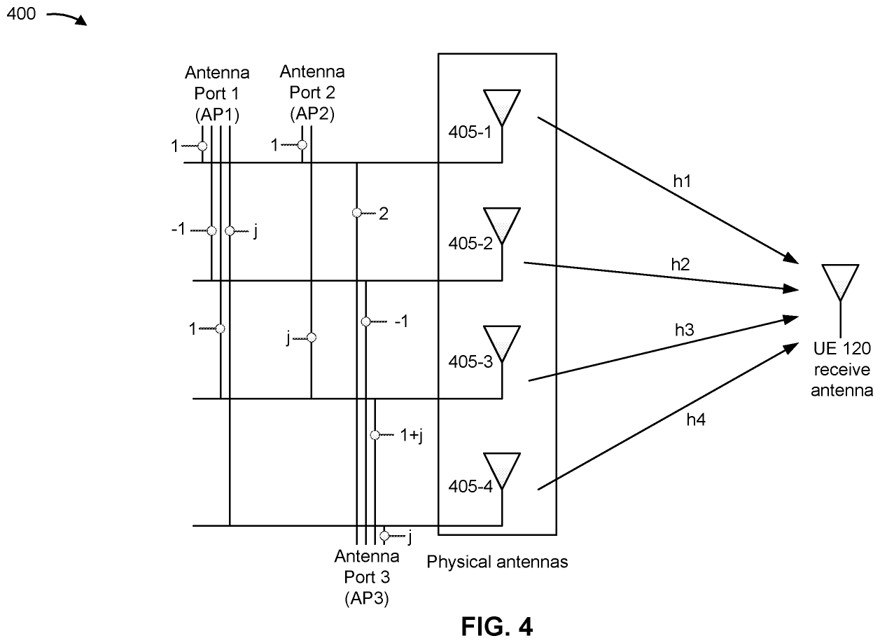

FIG. 4 is a diagram illustrating an example 400 of antenna ports, in accordance with the present disclosure.

As shown in FIG. 4, a first physical antenna 405-1 may transmit information via a first channel h1, a second physical antenna 405-2 may transmit information via a second channel h2, a third physical antenna 405-3 may transmit information via a third channel h3, and a fourth physical antenna 405-4 may transmit information via a fourth channel h4. Such information may be conveyed via a logical antenna port, which may represent some combination of the physical antennas and/or channels. In some cases, a UE 120 may not have knowledge of the channels associated with the physical antennas, and the UE 120 may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 400, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

Various antenna ports may be defined for uplink communication. For example, antenna ports that are identified starting from the number 0 (not shown) may be for DMRSs for a physical uplink shared channel (PUSCH). As another example, antenna ports that are identified starting with the number 1000 (not shown) may be for sounding reference signals (SRSs) or a PUSCH. As a further example, antenna ports that are identified starting with the number 2000 (not shown) may be for a PUCCH. As an additional example, antenna ports that are identified starting with the number 4000 (not shown) may be for a physical random access channel (PRACH).

As indicated above, FIG. 4 is provided merely as an example. Other examples may differ from what is described with regard to FIG. 4.

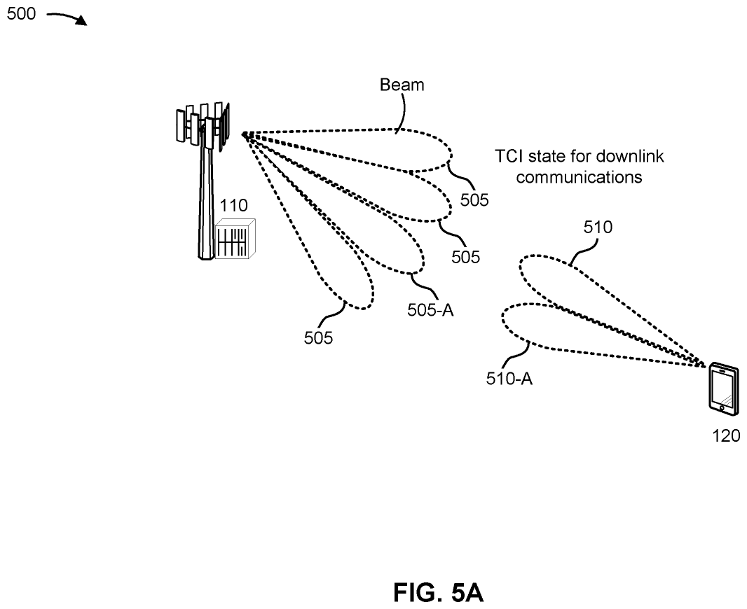

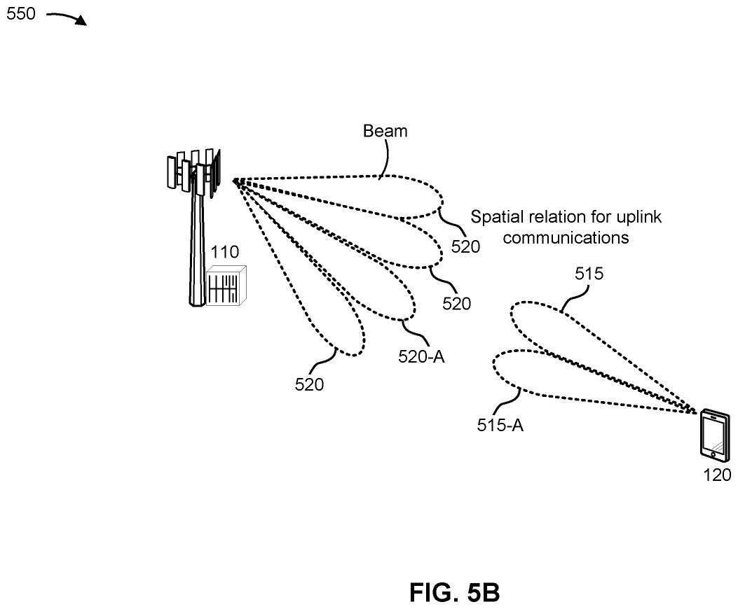

FIGS. 5A-5B are diagrams illustrating examples 500 and 550, respectively, of using beams for communications between a base station and a UE, in accordance with the present disclosure. As shown in FIGS. 5A-5B, a base station 110 and a UE 120 may communicate with one another.

As shown in FIG. 5A, the base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 505.

The UE 120 may attempt to receive downlink transmissions via one or more UE receive beams 510, which may be configured using different beamforming parameters at receive circuitry of the UE 120. The UE 120 may identify a particular BS transmit beam 505, shown as BS transmit beam 505-A, and a particular UE receive beam 510, shown as UE receive beam 510-A, that provide relatively favorable performance (for example, that have a best channel quality of the different measured combinations of BS transmit beams 505 and UE receive beams 510). In some examples, the UE 120 may transmit an indication of which BS transmit beam 505 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 505-A and the UE receive beam 510-A), which may be further refined and maintained in accordance with one or more established beam refinement procedures.

A downlink beam, such as a BS transmit beam 505 or a UE receive beam 510, may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each BS transmit beam 505 may be associated with a synchronization signal block (SSB), and the UE 120 may indicate a preferred BS transmit beam 505 by transmitting uplink transmissions in resources of the SSB that are associated with the preferred BS transmit beam 505. A particular SSB may have an associated TCI state (for example, for an antenna port or for beamforming). The base station 110 may, in some examples, indicate a downlink BS transmit beam 505 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 510 at the UE 120. Thus, the UE 120 may select a corresponding UE receive beam 510 from a set of BPLs based at least in part on the base station 110 indicating a BS transmit beam 505 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications as shown in FIG. 5B, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 515.

The base station 110 may receive uplink transmissions via one or more BS receive beams 520. The base station 110 may identify a particular UE transmit beam 515, shown as UE transmit beam 515-A, and a particular BS receive beam 520, shown as BS receive beam 520-A, that provide relatively favorable performance (for example, that have a best channel quality of the different measured combinations of UE transmit beams 515 and BS receive beams 520). In some examples, the base station 110 may transmit an indication of which UE transmit beam 515 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 515-A and the BS receive beam 520-A), which may be further refined and maintained in accordance with one or more established beam refinement procedures. An uplink beam, such as a UE transmit beam 515 or a BS receive beam 520, may be associated with a spatial relation. A spatial relation may indicate a directionality or a characteristic of the uplink beam, similar to one or more QCL properties, as described above.

The UE 120 may use one or more transmit beams 515 for transmitting UCI in a PUCCH, and the base station 110 may use one or more receive beams 520 for receiving the UCI in the PUCCH. For example, the UE 120 may simultaneously use multiple transmit beams 515 for transmitting the UCI in the PUCCH, and the base station 110 may simultaneously use multiple receive beams 520 for receiving the UCI in the PUCCH, as described herein.

As indicated above, FIGS. 5A-5B are provided as examples. Other examples may differ from what is described with respect to FIGS. 5A-5B.

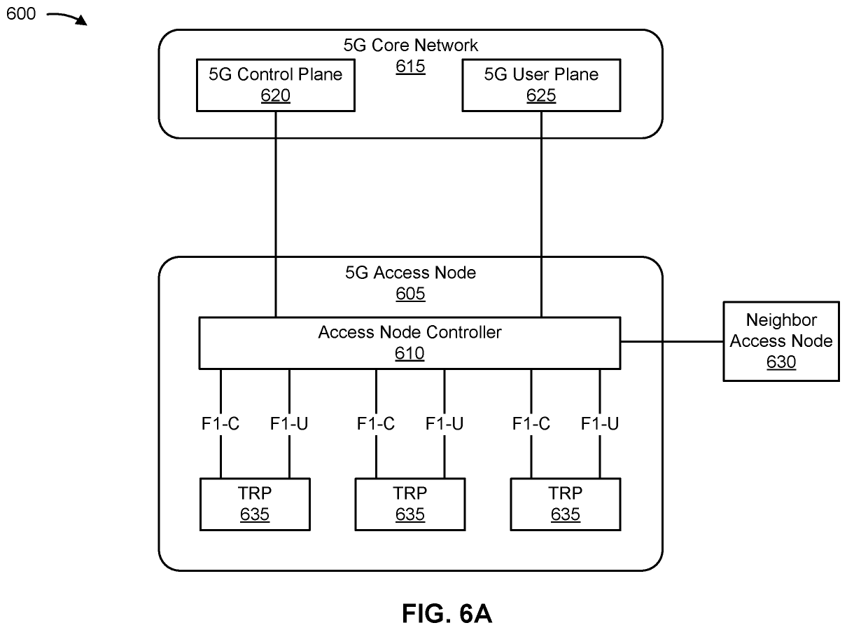

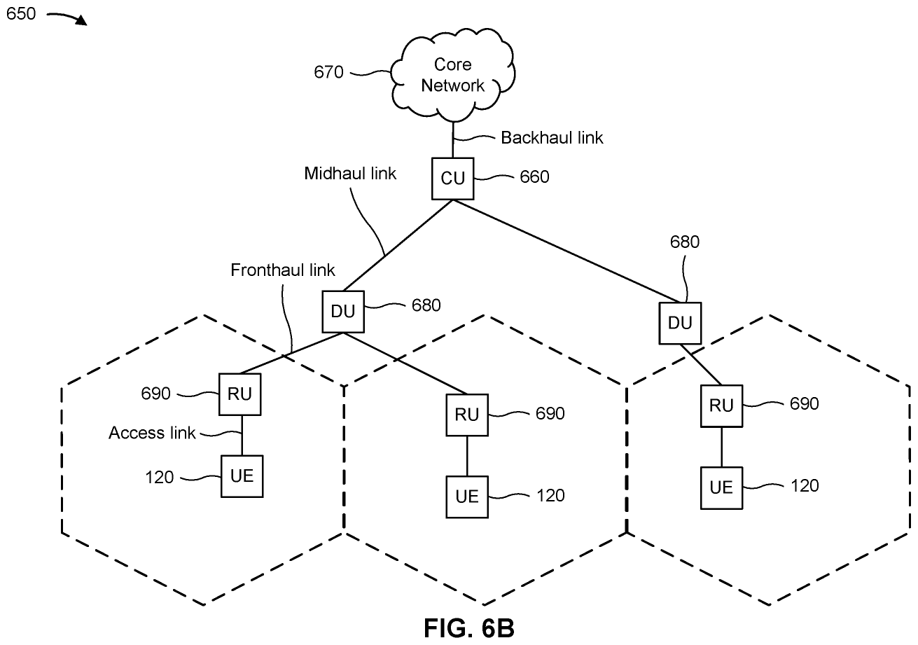

FIG. 6A illustrates an example logical architecture of a distributed RAN 600, in accordance with the present disclosure.

A 5G access node 605 may include an access node controller 610. The access node controller 610 may be a central unit (CU) of the distributed RAN 600. In some aspects, a backhaul interface to a 5G core network 615 may terminate at the access node controller 610. The 5G core network 615 may include a 5G control plane component 620 and a 5G user plane component 625 (e.g., a 5G gateway), and the backhaul interface for one or both of the 5G control plane and the 5G user plane may terminate at the access node controller 610. Additionally, or alternatively, a backhaul interface to one or more neighbor access nodes 630 (e.g., another 5G access node 605 and/or an LTE access node) may terminate at the access node controller 610.

The access node controller 610 may include and/or may communicate with one or more TRPs 635 (e.g., via an F1 Control (F1-C) interface and/or an F1 User (F1-U) interface). A TRP 635 may be a distributed unit (DU) of the distributed RAN 600. In some aspects, a TRP 635 may correspond to a base station 110 described above in connection with FIG. 1. For example, different TRPs 635 may be included in different base stations 110. Additionally, or alternatively, multiple TRPs 635 may be included in a single base station 110. In some aspects, a base station 110 may include a CU (e.g., access node controller 610) and/or one or more DUs (e.g., one or more TRPs 635). In some cases, a TRP 635 may be referred to as a cell, a panel, an antenna array, or an array.

A TRP 635 may be connected to a single access node controller 610 or to multiple access node controllers 610. In some aspects, a dynamic configuration of split logical functions may be present within the architecture of distributed RAN 600. For example, a packet data convergence protocol (PDCP) layer, a radio link control (RLC) layer, and/or a medium access control (MAC) layer may be configured to terminate at the access node controller 610 or at a TRP 635.

In some aspects, multiple TRPs 635 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships. A TRP 635 may be configured to individually (e.g., using dynamic selection) or jointly (e.g., using joint transmission with one or more other TRPs 635) serve traffic to a UE 120.

As indicated above, FIG. 6A is provided as an example. Other examples may differ from what was described with regard to FIG. 6A.

FIG. 6B is a diagram illustrating an example 650 of an open RAN (O-RAN) architecture, in accordance with the present disclosure. As shown in FIG. 6B, the O-RAN architecture may include a CU 660 that communicates with a core network 670 via a backhaul link. Furthermore, the CU 660 may communicate with one or more DUs 680 via respective midhaul links. The DUs 680 may each communicate with one or more radio units (RUs) 690 via respective fronthaul links, and the RUs 690 may each communicate with respective UEs 120 via radio frequency (RF) access links. The DUs 680 and the RUs 690 may also be referred to as O-RAN DUS (O-DUs) 680 and O-RAN RUs (O-RUs) 690, respectively.

In some aspects, the DUs 680 and the RUs 690 may be implemented according to a functional split architecture in which functionality of a base station 110 (e.g., an eNB or a gNB) is provided by a DU 680 and one or more RUs 690 that communicate over a fronthaul link. Accordingly, as described herein, a base station 110 may include a DU 680 and one or more RUs 690 that may be co-located or geographically distributed. In some aspects, the DU 680 and the associated RU(s) 690 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 680 may correspond to a logical unit that includes one or more base station functions to control the operation of one or more RUs 690. For example, in some aspects, the DU 680 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), RRC, and/or service data adaptation protocol (SDAP), may be hosted by the CU 660. The RU(s) 690 controlled by a DU 680 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 690 handle all over the air (OTA) communication with a UE 120, and real-time and non-real-time aspects of control and user plane communication with the RU(s) 690 are controlled by the corresponding DU 680, which enables the DU(s) 680 and the CU 660 to be implemented in a cloud-based RAN architecture.

As indicated above, FIG. 6B is provided as an example. Other examples may differ from what is described with regard to FIG. 6B.

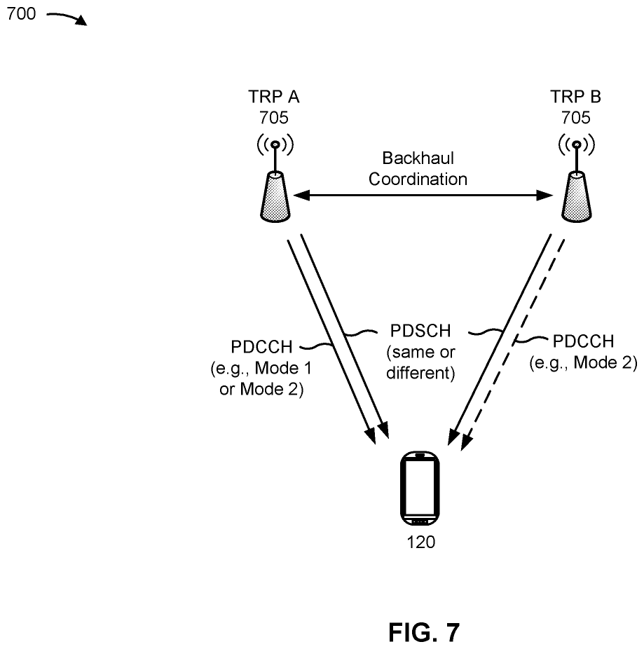

FIG. 7 is a diagram illustrating an example 700 of multi-TRP communication (sometimes referred to as multi-panel communication), in accordance with the present disclosure. As shown in FIG. 7, multiple TRPs 705 may communicate with the same UE 120. A TRP 705 may correspond to a TRP 635 described above in connection with FIG. 6A.

The multiple TRPs 705 (shown as TRP A and TRP B) may communicate with the same UE 120 in a coordinated manner (e.g., using coordinated multipoint transmissions) to improve reliability and/or increase throughput. The TRPs 705 may coordinate such communications via an interface between the TRPs 705 (e.g., a backhaul interface and/or an access node controller 610). The interface may have a smaller delay and/or higher capacity when the TRPs 705 are co-located at the same base station 110 (e.g., when the TRPs 705 are different antenna arrays or panels of the same base station 110), and may have a larger delay and/or lower capacity (as compared to co-location) when the TRPs 705 are located at different base stations 110. The different TRPs 705 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 705 (e.g., TRP A and TRP B) may transmit communications to the UE 120 on the same PDSCH. For example, a communication may be transmitted using a single codeword with different spatial layers for different TRPs 705 (e.g., where one codeword maps to a first set of layers transmitted by a first TRP 705 and maps to a second set of layers transmitted by a second TRP 705). As another example, a communication may be transmitted using multiple codewords, where different codewords are transmitted by different TRPs 705 (e.g., using different sets of layers). In either case, different TRPs 705 may use different QCL relationships (e.g., different TCI states) for different DMRS ports corresponding to different layers. For example, a first TRP 705 may use a first QCL relationship or a first TCI state for a first set of DMRS ports corresponding to a first set of layers, and a second TRP 705 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 705, and a second PDCCH may schedule a second codeword to be transmitted by a second TRP 705. Furthermore, first DCI (e.g., transmitted by the first TRP 705) may schedule a first PDSCH communication associated with a first set of DMRS ports with a first QCL relationship (e.g., indicated by a first TCI state) for the first TRP 705, and second DCI (e.g., transmitted by the second TRP 705) may schedule a second PDSCH communication associated with a second set of DMRS ports with a second QCL relationship (e.g., indicated by a second TCI state) for the second TRP 705. In this case, DCI (e.g., having DCI format 1_0 or DCI format 1_1) may indicate a corresponding TCI state for a TRP 705 corresponding to the DCI. The TCI field of a DCI indicates the corresponding TCI state (e.g., the TCI field of the first DCI indicates the first TCI state and the TCI field of the second DCI indicates the second TCI state).

The UE 120 may transmit UCI in a PUCCH using multiple simultaneous beams. For example, the UE 120 may transmit the UCI (e.g., a part of the UCI or a repetition of the UCI) to a first TRP 705 using a first beam, and the UE 120 may transmit the UCI (e.g., another part of the UCI or another repetition of the UCI) to a second TRP 705 using a second beam.

As indicated above, FIG. 7 is provided as an example. Other examples may differ from what is described with respect to FIG. 7.

A UE may transmit a PUCCH that may carry various UCI for the UE, such as channel state information, a scheduling request, HARQ feedback (e.g., an ACK or NACK), or the like. The UE may transmit the PUCCH using a PUCCH resource. A PUCCH resource configuration for a PUCCH resource may be indicated by a base station, for example, in an RRC message, or the like. The PUCCH resource configuration may include information identifying a PUCCH resource identifier for the PUCCH resource, a PUCCH format (e.g., a long PUCCH format, a short PUCCH format, or the like), a starting PRB of the PUCCH, a quantity of PRBs of the PUCCH, or the like.

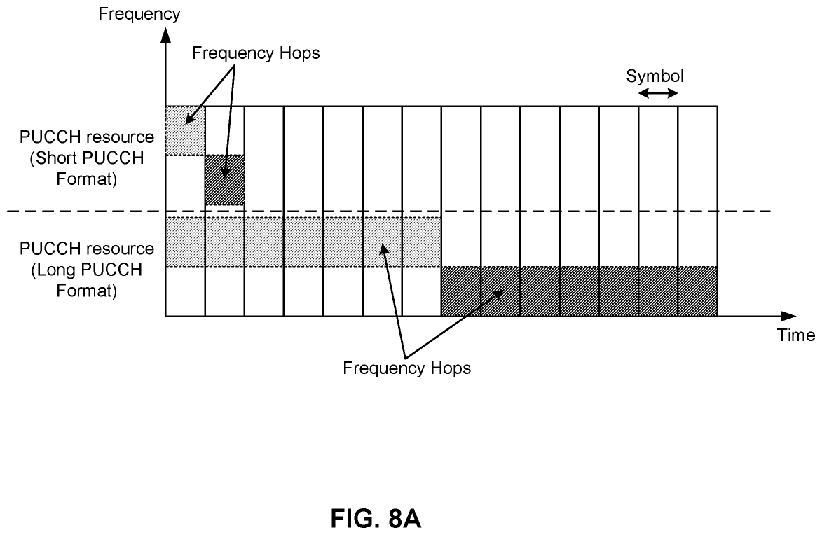

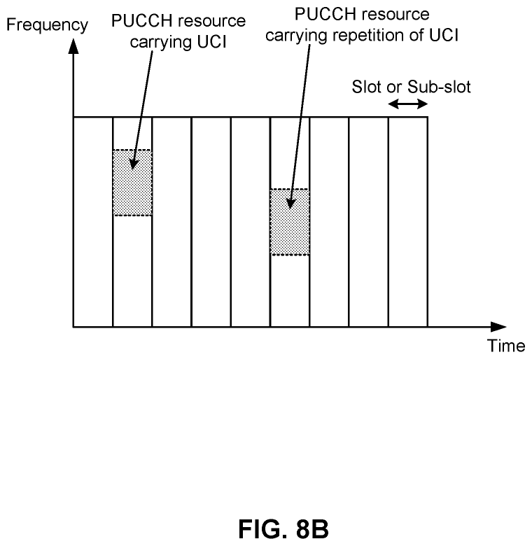

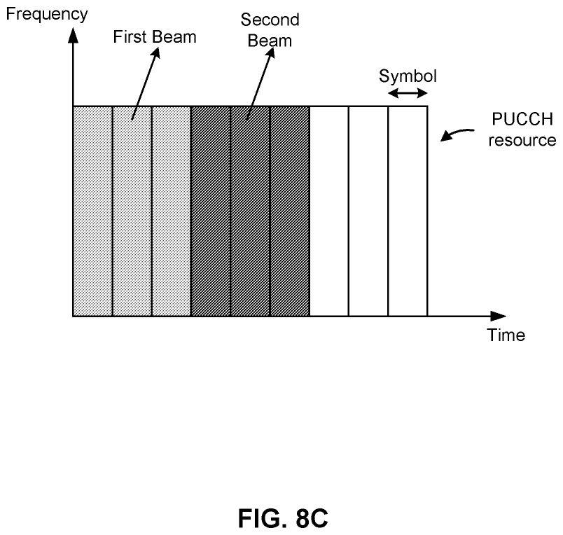

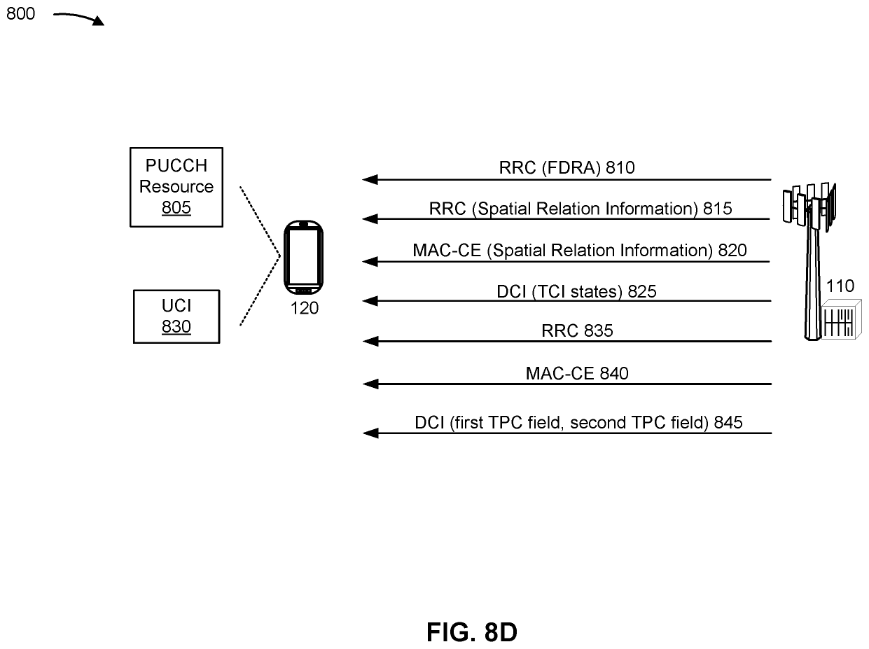

FIG. 8A is a diagram illustrating an example of frequency hopping within a PUCCH resource, in accordance with the present disclosure. In some examples, frequency hopping may be used within a PUCCH resource. For example, the PUCCH resource configuration may include information identifying whether intra-slot frequency hopping is enabled (e.g., using an intraSlotFrequencyHopping parameter). The use of intra-slot frequency hopping may be assumed when the higher-layer parameter intraSlotFrequencyHopping is enabled. As shown, for a short PUCCH format using two symbols (e.g., PUCCH format 0 or 2), a first symbol may be for the first frequency hop and a second symbol may be for the second frequency hop. For a long PUCCH format with 4-14 symbols (e.g., PUCCH format 1, 3, or 4), a quantity of symbols in the first frequency hop may be a floor of N÷2, and a quantity of symbols in the second frequency hop may be a ceiling of N÷2, where Nis the length of the PUCCH transmission in OFDM symbols. The PUCCH resource configuration may include information identifying a starting PRB of the second frequency hop. As indicated above, FIG. 8A is provided as an example. Other examples may differ from what is described with respect to FIG. 8A.

FIG. 8B is a diagram illustrating an example of UCI repetition, in accordance with the present disclosure. In some examples, a multi-TRP PUCCH transmission scheme may be employed. In some examples, multi-TRP inter-slot repetition may be used. For example, one PUCCH resource may carry UCI, and another PUCCH resource or the same PUCCH resource in another one or more slots may carry a repetition of the UCI. The quantity of repetitions may be two or more (e.g., where the initial transmission of the UCI may be considered as the first repetition). In some examples, multi-TRP intra-slot repetition may be used. For example, one PUCCH resource may carry UCI, and another PUCCH resource or the same PUCCH resource in another one or more sub-slots within a slot may carry a repetition of the UCI. In some examples, the same PUCCH resource carrying UCI may be repeated for two or more sub-slots (e.g., consecutive or non-consecutive sub-slots) within a slot. As indicated above, FIG. 8B is provided as an example. Other examples may differ from what is described with respect to FIG. 8B.

FIG. 8C is a diagram illustrating an example of beam hopping within a PUCCH resource, in accordance with the present disclosure. In some examples, as described above, a multi-TRP PUCCH transmission scheme may be employed. In some examples, multi-TRP intra-slot beam hopping may be used. Multi-TRP intra-slot beam hopping refers to the use (e.g., by a UE) of different beams in different sets of symbols within a slot for transmission to different TRPs. For example, UCI may be transmitted in one PUCCH resource in which different sets of symbols within the PUCCH resource may be associated with different beams (shown in FIG. 8C as “first beam” and “second beam”). The quantity of beam hopping instances in a PUCCH resource may be two or more. As indicated above, FIG. 8C is provided as an example. Other examples may differ from what is described with respect to FIG. 8C.

Multi-TRP inter-slot repetition (that is, the transmission to different TRPs of different repetitions in different slots) or intra-slot repetition (that is, the transmission to different TRPs of different repetitions in different sets of symbols within the same slot) may use two PUCCH resources or the same PUCCH resource with different beams. In addition, multi-TRP inter-slot repetition, multi-TRP intra-slot repetition, and/or multi-TRP beam hopping may be supported for all short and long PUCCH formats (e.g., PUCCH formats 0, 1, 2, 3, and 4). For multi-TRP PUCCH transmission schemes that use time domain multiplexing (TDM), the use of a single PUCCH resource may be supported. Here, up to two spatial relation information may be activated per PUCCH resource via a medium access control control element (MAC-CE). In some examples, multiple PUCCH resources may be used for multi-TRP PUCCH transmission schemes that use TDM.

In some examples, for multi-TRP PUCCH transmission schemes, only one power control parameter (e.g., twoPUCCH-PC-AdjustmentStates) may be configured for multiple (e.g., both) TRPs. Here, the power control parameter may be shared across both TRPs, such that there are two closed loops in total. To support per-TRP closed-loop power control for PUCCH (e.g., in connection with DCI formats 1_1 and 1_2), a second transmit power control (TPC) field (in addition to a first TPC field used by the DCI) may be configured via RRC. If the second TPC field is configured by RRC, a second TPC field (e.g., similar to the existing TPC field that is used) may be added in DCI (e.g., in DCI formats 1_1 and 1_2). Each TPC field may be respectively associated with each closed-loop index value for a UE. In some examples, an association between a TPC field and a PUCCH transmission may be in accordance with a mapping. If the second TPC field is not configured by RRC, a single TPC field may be used in DCI (e.g., in DCI formats 1_1 and 1_2), and the TPC value may be applied for closed loop index(es) for a scheduled PUCCH. In some examples, per-TRP closed-loop power control for a PUSCH (e.g., in connection with DCI formats 0_1 and 0_2) may be supported using a similar scheme as described above for multi-TRP PUCCH.

In some examples, a UE may provide a capability report on whether the UE supports a second TPC field. In some examples, per-TRP closed-loop power control may be applicable only when closed-loop index (e.g., closedLoopIndex) values are not the same for different TRPs.

FIG. 8D is a diagram illustrating an example 800 of PUCCH configuration and scheduling, in accordance with the present disclosure. As shown in FIG. 8D, a base station 110 may configure at least one PUCCH resource 805 for a UE 120. As further shown, a frequency domain resource allocation (FDRA) of the PUCCH resource 805 may be configured in an RRC message 810. In some examples, spatial relation information for the PUCCH resource 805 may be configured in an RRC message 815 (e.g., which may be the same as, or different from, the RRC message 810). In some examples, one or more spatial relation information (e.g., multiple, such as two, spatial relation information for PUCCH transmission in the PUCCH resource 805 using simultaneous beams) may be activated for the PUCCH resource 805 in a MAC-CE 820. In some examples, DCI 825 may indicate one or more TCI states (e.g., multiple, such as two, TCI states for PUCCH transmission in the PUCCH resource 805 using simultaneous beams) for the PUCCH resource 805. For example, the DCI may indicate multiple (e.g., two) unified, or joint, TCI states (e.g., used for uplink and downlink) or multiple (e.g., two) uplink TCI states.

As further shown in FIG. 8D, the UE 120 may use the PUCCH resource 805 for transmitting UCI 830. Transmission of the UCI 830 may be scheduled by an RRC message 835, a MAC-CE 840, or DCI 845. In some examples, the DCI 845 may include multiple TPC commands (e.g., in a first TPC field and in a second TPC field).

In some examples, a UE 120 may perform simultaneous PUSCH transmission using multiple beams. A frequency domain resource allocation for the simultaneous PUSCH transmission may be indicated in DCI. That is, the frequency domain resource allocation for the simultaneous PUSCH transmission may be dynamically indicated by DCI. Simultaneous PUCCH transmission using multiple beams may improve a spatial diversity of the PUCCH, a performance of the PUCCH, or the like. However, as described above, a frequency domain resource allocation for a PUCCH may be indicated by RRC signaling, which is much more static relative to the dynamic signaling used for simultaneous PUSCH transmission. Accordingly, simultaneous PUCCH transmission should be enabled using different mechanisms than those used to enable simultaneous PUSCH transmission.

Some techniques and apparatuses described herein enable a PUCCH transmission using multiple beams in a common time domain resource. That is, the PUCCH transmission using multiple beams may be simultaneous. In some aspects, a PUCCH resource used for the PUCCH transmission may include multiple (e.g., two) sets of PRBs (e.g., in a frequency division multiplexed manner), and respective beams may be used for transmission of UCI in respective sets of PRBs. In some aspects, respective parts of the UCI may be transmitted in the respective sets of PRBs. In some aspects, respective repetitions of the UCI may be transmitted in the respective sets of PRBs (e.g., PUCCH repetition in a frequency division multiplexed manner and in a spatial domain). In some aspects, a PUCCH resource used for the transmission may include a single set of PRBs, and respective beams may be used for transmission of UCI in the single set of PRBs (e.g., all PRBs of the PUCCH resource are transmitted in a single frequency network manner and using a single antenna port).

In this way, the simultaneous PUCCH transmission described herein may improve a frequency diversity of the PUCCH transmission and/or a spatial diversity of the PUCCH transmission. Accordingly, a performance of the PUCCH transmission may be improved, thereby improving a timeliness, a usefulness, or the like, of the UCI.

As indicated above, FIG. 8D is provided as an example. Other examples may differ from what is described with respect to FIG. 8D.

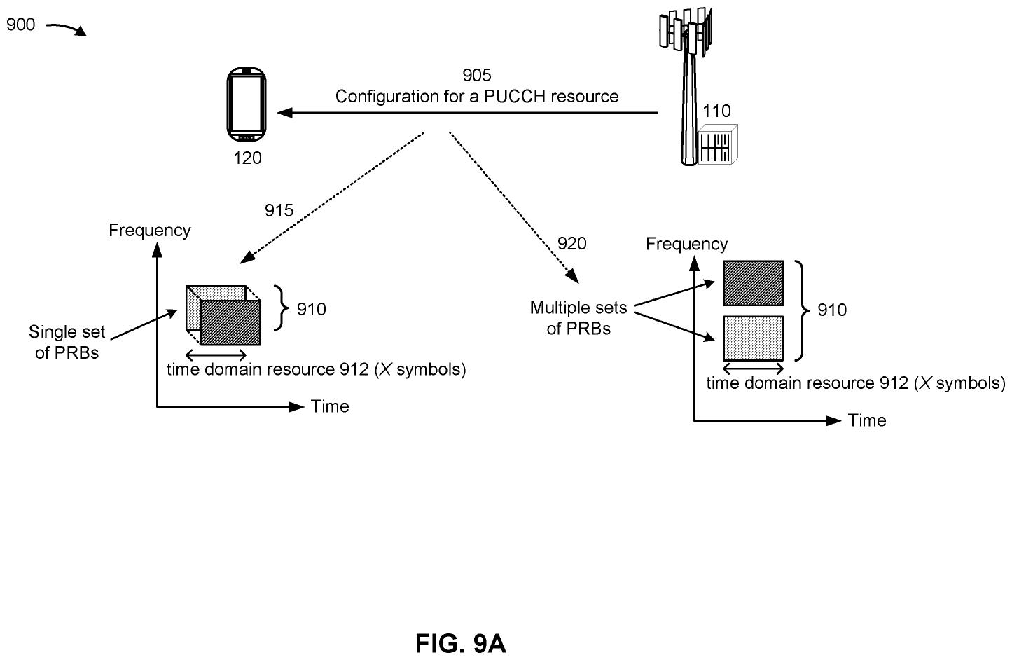

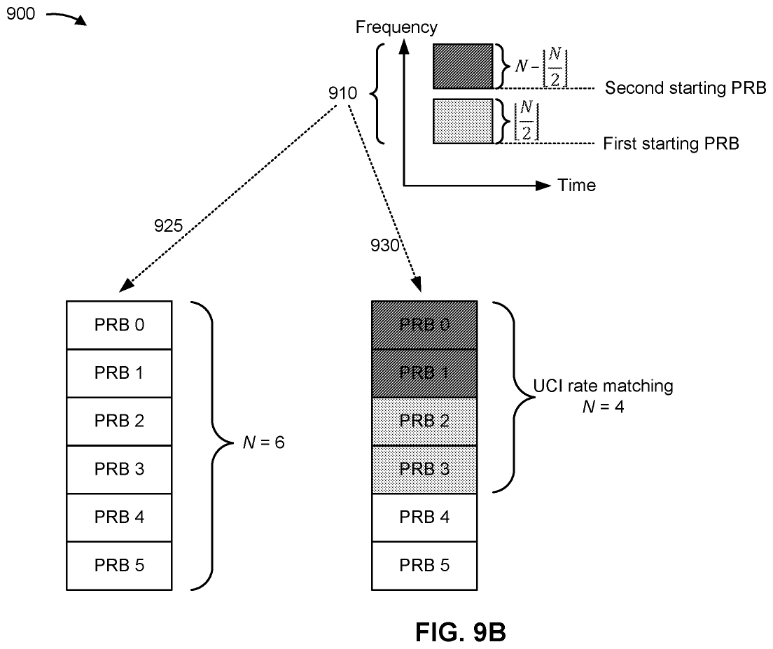

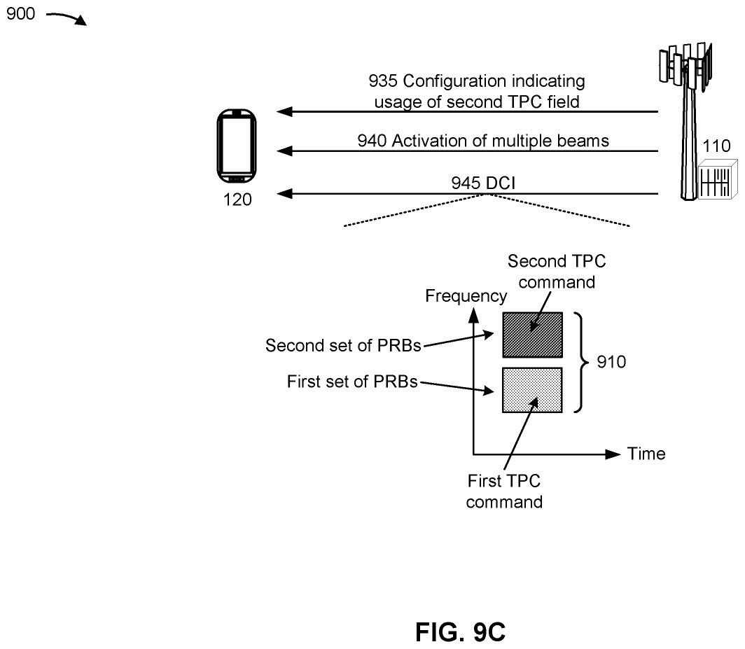

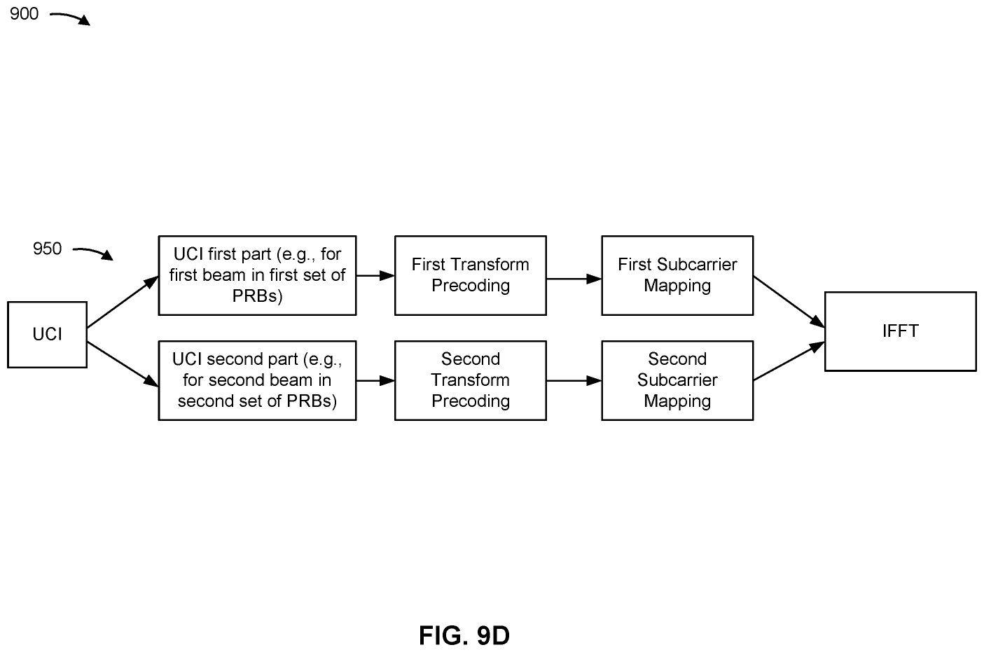

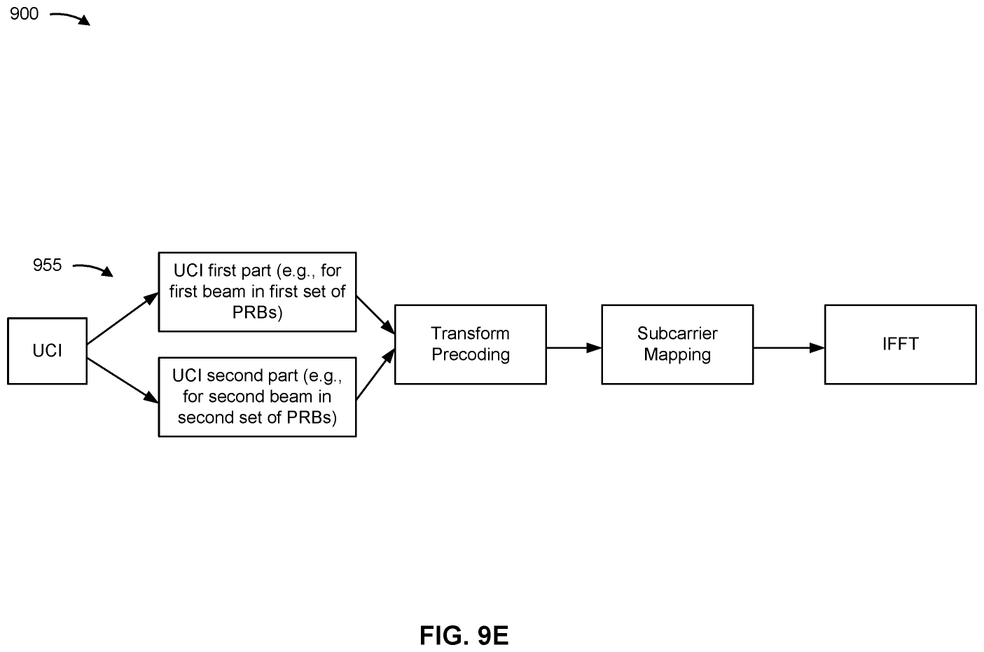

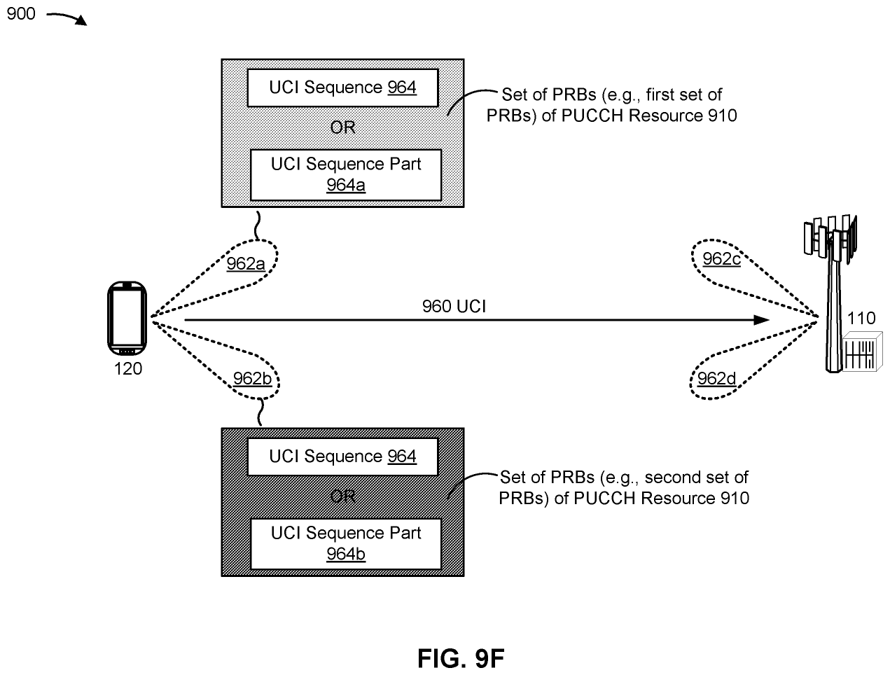

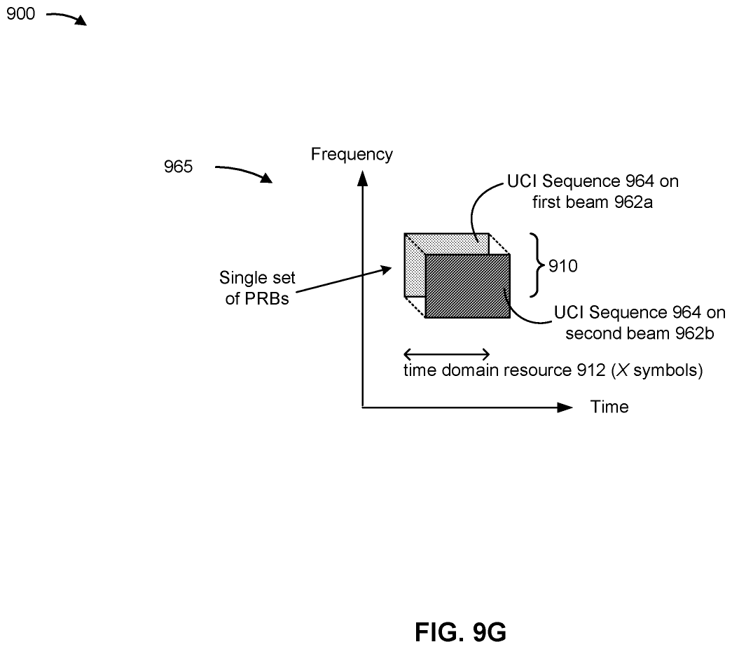

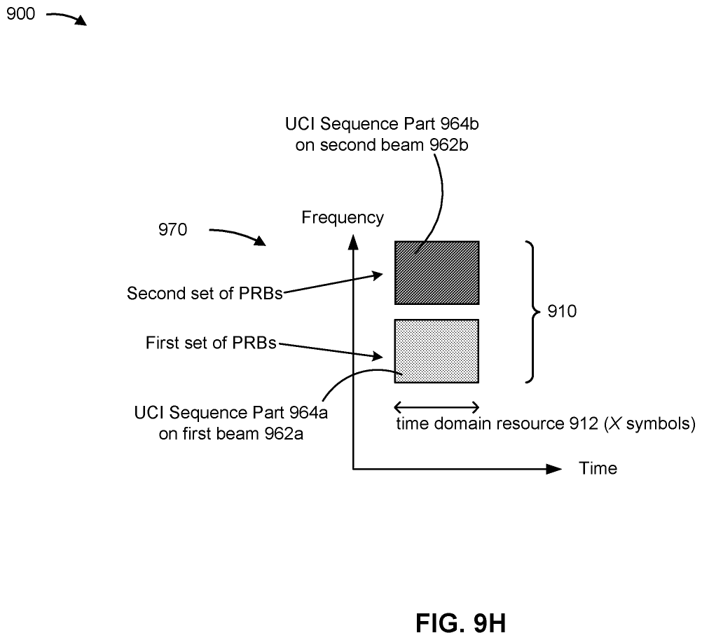

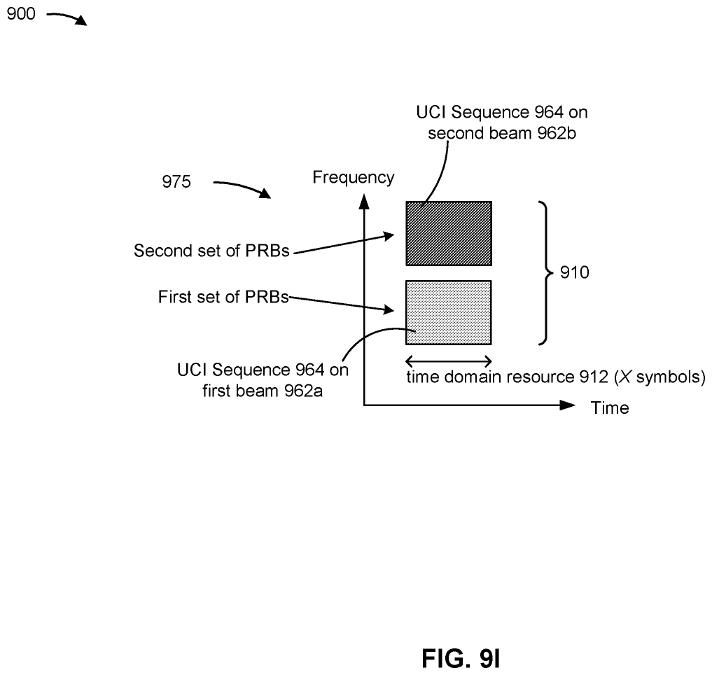

FIGS. 9A-9I are diagrams illustrating one or more examples 900 associated with PUCCH transmission with simultaneous (e.g., occurring in a same time domain resource or in overlapping time domain resources) beams, in accordance with the present disclosure. As shown in FIGS. 9A-9I, example 900 includes communication between a base station 110 and a UE 120. In some aspects, the base station 110 and the UE 120 may be included in a wireless network, such as wireless network 100. The base station 110 and UE 120 may communicate via a wireless access link, which may include an uplink and a downlink. In some aspects, the UE 120 may communicate with the base station 110 via a first TRP and/or a second TRP (not shown).

As shown in FIG. 9A, and by reference number 905, the base station 110 (e.g., via a TRP) may transmit, and the UE 120 may receive, a configuration for a PUCCH resource 910. The PUCCH resource 910 may be for a transmission using multiple (e.g., two) beams in a common time domain resource 912 (e.g., a starting symbol and a quantity of symbols is the same for the multiple beams). In other words, the PUCCH resource 910 may be for multiple (e.g., two) simultaneous beams. In some aspects, the configuration for the PUCCH resource 910 may indicate that simultaneous beams are enabled for the PUCCH resource 910 (e.g., using a simultaneousbeams parameter).

In some aspects, as shown by reference number 915, the PUCCH resource 910 includes a single set of PRBs (e.g., including one or more PRBs). Here, the multiple beams may be used simultaneously in the single set of PRBs. In some aspects, as shown by reference number 920, the PUCCH resource 910 includes multiple sets of PRBs (e.g., each set of PRBs including one or more PRBs). Here, the multiple beams may be used respectively in the multiple sets of PRBs, where each beam is applied to transmit a set of PRBs.

As shown in FIG. 9B, in some aspects, the configuration for the PUCCH resource 910 may indicate a first starting PRB for a first set of PRBs of the multiple sets of PRBs and a second starting PRB for a second set of PRBs of the multiple sets of PRBs. That is, the configuration may indicate the first starting PRB and the second starting PRB using respective parameters of the configuration. For example, the configuration may include a first parameter (e.g., a firstbeamPRB parameter) to indicate the first starting PRB and a second parameter (e.g., a secondbeamPRB parameter) to indicate the second starting PRB.

In some aspects, the configuration may configure the PUCCH resource 910 with a PUCCH format associated with a single PRB in a set of PRBs (e.g., of the multiple sets of PRBs). For example, the configuration may indicate PUCCH format 0, 1, or 4. Here, UCI for transmission in the PUCCH resource may be repeated in a first PRB indexed by the first starting PRB (e.g., indexed by the first parameter, for example, firstbeamPRB) and in a second PRB indexed by the second starting PRB (e.g., indexed by the second parameter, for example, secondbeamPRB). In other words, the UE may perform two identical transmissions of a PUCCH (e.g., a 3GPP Release 15 PUCCH) in two PRBs indexed by the first starting PRB and the second starting PRB.

In some aspects, the configuration may configure the PUCCH resource 910 with a PUCCH format associated with multiple PRBs in a set of PRBs (e.g., of the multiple sets of PRBs). For example, the configuration may indicate PUCCH format 2 or 3. Here, the first set of PRBs of the multiple sets of PRBs may be indexed by the first starting PRB (e.g., indexed by the first parameter, for example, firstbeamPRB), and the second set of PRBs of the multiple sets of PRBs may be indexed by the second starting PRB (e.g., indexed by the second parameter, for example, secondbeamPRB).

In some aspects, the configuration may indicate for the PUCCH resource 910, or the PUCCH resource 910 may be associated with, a quantity of PRBs (e.g., indicated by a nrofPRBs parameter). In some aspects, the quantity of PRBs for the PUCCH resource 910 may be split between the first set of PRBs and the second set of PRBs. In other words, if N equals the quantity of PRBs (e.g., N=nrofPRBs), then the first set of PRBs may include (and a first beam, of the multiple beams, may be associated with) a ceiling or a floor of N÷2 PRBs and the second set of PRBs may include (and a second beam, of the multiple beams, may be associated with) a floor or a ceiling of N÷2 PRBs. In some aspects, the quantity of PRBs for the PUCCH resource 910 may be used for the first set of PRBs and the quantity of PRBs for the PUCCH resource 910 may also be used for the second set of PRBs. That is, N may equal double the quantity of PRBs (e.g., N=2×nrofPRBs). In some aspects, as shown by reference number 925, the quantity of PRBs for the PUCCH resource 910 may be an indicated quantity of PRBs for the PUCCH resource (e.g., nrofPRBs) before rate matching of UCI to the PUCCH resource 910 is performed by the UE 120. In some aspects, as shown by reference number 930, the quantity of PRBs for the PUCCH resource 910 may be an actual quantity of PRBs used for the PUCCH resource 910 after rate matching of UCI to the PUCCH resource 910 is performed by the UE 120 (e.g., where the transmission of the PUCCH resource may use a quantity of PRBs that is less than indicated by the configuration due to rate matching of UCI). In rate matching, reserved resources do not have modulated symbols as if these resources are not allocated to the channel.

As shown in FIG. 9C, and by reference number 935, the base station 110 may transmit (e.g., via a TRP), and the UE 120 may receive, a configuration indicating usage of a first TPC field and a second TPC field in DCI (e.g., DCI format 1_1 or 1_2). For example, the configuration may indicate that the second TPC field is enabled. Use of the first and second TPC fields may enable per-beam closed-loop power control for PUCCH. The configuration indicating usage of the first and second TPC fields and the configuration for the PUCCH resource 910 may be included the same message (e.g., the same RRC message) or different messages (e.g., different RRC messages).

As shown by reference number 940, the base station 110 may transmit (e.g., via a TRP), and the UE 120 may receive, an activation of the multiple beams for the PUCCH resource 910. That is, the PUCCH resource 910 may be activated with multiple (e.g., two) beams. In some aspects, the activation of the multiple beams for the PUCCH resource 910 is an activation of multiple spatial relations in a MAC-CE or of multiple TCI states in DCI. For example, the DCI may indicate multiple (e.g., a pair of) joint TCI states or multiple (e.g., a pair of) uplink TCI states that are applicable to a PUCCH resource.

As shown by reference number 945, the base station 110 may transmit (e.g., via a TRP), and the UE 120 may receive, DCI. The DCI may indicate a resource allocation for a PUCCH. For example, the DCI may indicate that the UE 120 is to use the PUCCH resource 910 for transmission of UCI (e.g., HARQ feedback for a PDSCH scheduled by the DCI). The DCI may be DCI format 1_1 or 1_2. In some implementations, the PUCCH may be scheduled by different signaling than DCI, such as by RRC signaling (e.g., by a configured grant), or the like.

In some aspects, as shown, the DCI may indicate a first TPC command (e.g., in the first TPC field) and a second TPC command (e.g., in the second TPC field). For example, if the configuration indicates usage of the first TPC field and the second TPC field, then the first TPC field and the second TPC field are used in DCI (e.g., the second TPC field is added in DCI formats 1_1 and 1_2). Each of the first TPC command (e.g., indicated by the first TPC field) and the second TPC command (e.g., indicated by the second TPC field) may be for respective closed-loop index values for the UE 120. For example, a first closed-loop index value may be associated with the first set of PRBs of the multiple sets of PRBs and a second closed-loop index value may be associated with the second set of PRBs of the multiple sets of PRBs. Thus, the UE 120 may determine respective transmit powers for the multiple sets of PRBs of the PUCCH resource 910 independently. In other words, the first TPC command may be for the first set of PRBs of the multiple sets of PRBs and the second TPC command may be for the second set of PRBs of the multiple sets of PRBs. A TPC command may include a TPC value that indicates an adjustment (e.g., in decibels) to a transmit power of the UE 120.

In some aspects, the DCI may indicate a single TPC command (e.g., in the first TPC field). For example, if the configuration does not indicate usage of the first TPC field and the second TPC field (e.g., the configuration does not enable the second TPC field), then a single TPC field is used in DCI (e.g., in DCI formats 1_1 and 1_2). The single TPC command may be applied for closed-loop index(es) of the PUCCH. In other words, the single TPC command may be split between the first set of PRBs of the multiple sets of PRBs and the second set of PRBs of the multiple sets of PRBs. That is, the UE 120 may split the transmit power indicated by the TPC command between the first set of PRBs and the second set of PRBs.

In some aspects, the UE 120 may apply a transform precoding (e.g., for DFT-s-OFDM) to the PUCCH (e.g., to the UCI). As shown in FIG. 9D, and by reference number 950, a first transform precoding may be used for the first set of PRBs of the multiple sets of PRBs and a second transform precoding may be used for the second set of PRBs of the multiple sets of PRBs (e.g., the UE 120 may apply different and independent transform precodings at respective sets of PRBs). For example, as shown, the UE 120 may split the UCI sequence (e.g., if the PUCCH resource 910 used for the simultaneous multiple beams is configured with a long PUCCH format) into a first part for transmission in the first set of PRBs using the first beam and a second part for transmission in the second set of PRBs using the second beam. Continuing with the example, the UE 120 may apply the first transform precoding (discrete Fourier transform (DFT)-based transform) to the first part and use a first subcarrier mapping for the first part before performing an inverse fast Fourier transform (IFFT) on the first part (e.g., and additionally performing CP insertion for the second part after the IFFT), and the UE 120 may apply the second transform precoding to the second part and use a second subcarrier mapping for the second part before performing an IFFT on the second part (e.g., and additionally performing CP insertion for the second part after the IFFT). In some aspects, different transform precodings may be used for the different sets of PRBs in connection with a per-panel transmit power limitation and/or a peak-to-average power ratio (PAPR) limitation, and/or if the first set of PRBs and the second set of PRBs are sufficiently separated in frequency (e.g., separated by a threshold frequency span).

As shown in FIG. 9E, and by reference number 955, a single transform precoding may be used for the first set of PRBs of the multiple sets of PRBs and the second set of PRBs of the multiple sets of PRBs (e.g., the UE 120 may apply the same transform precoding at respective sets of PRBs). For example, as shown, the UE 120 may split the UCI sequence (e.g., if the PUCCH resource 910 used for the simultaneous multiple beams is configured with a long PUCCH format) into a first part for transmission in the first PRB set using the first beam and a second part for transmission in the second PRB set using the second beam. Continuing with the example, the UE 120 may apply the single transform precoding (DFT-based transform) both to the first part and to the second part and use a single subcarrier mapping for the first part and the second part before performing an IFFT on the first part and the second part (e.g., and additionally performing CP insertion for the first part and the second part after the IFFT).

As shown in FIG. 9F, and by reference number 960, the UE 120 may transmit, and the base station 110 may receive (e.g., via a first TRP and a second TRP) the UCI (e.g., a UCI sequence 964, or a UCI sequence part 964a, 964b, where a combination of UCI sequence part 964a and UCI sequence part 964b correspond to UCI sequence 964) using the multiple beams 962 (shown as transmit beams 962a, 962b and receive beams 962c, 962d) in the common time domain resource 912 (e.g., the UE 120 may transmit the UCI using multiple simultaneous beams 962a, 962b). In some aspects, the base station 110 may determine one or more parameters for the UE 120 based at least in part on the UCI and/or perform one or more operations based at least in part on the UCI. For example, the base station 110 may determine and signal one or more power control parameters for the UE 120, determine and signal one or more beams for the UE 120, signal scheduling for the UE 120, perform a retransmission to the UE 120, or the like.

As shown in FIG. 9G, in some aspects (e.g., if the PUCCH resource 910 includes the single set of PRBs), the UE 120 may transmit the UCI using the multiple beams 962a, 962b in the single set of PRBs (e.g., the UE 120 may transmit UCI sequence 964 on the first beam 962a and transmit the UCI sequence 964 on the second beam 962b). For example, as shown by reference number 965, the UE 120 may transmit the UCI (e.g., UCI sequence 964) in a single frequency network manner (e.g., at the same time and over the same frequency channel). In addition, the UCI may be rate matched to the single set of PRBs in connection with the first beam 962a of the multiple beams and the second beam 962b of the multiple beams. In other words, the UCI may be rate matched to the single set of PRBs in a manner irrespective of whether the UE 120 is using a single beam or multiple beams. Moreover, the UE 120 may transmit the UCI using the multiple beams in the single set of PRBs using a single antenna port, and the base station 110 may receive the UCI in accordance with the transmission using the single antenna port (e.g., the base station 110 may receive a single copy of the signal using the multiple beams).

In some aspects, (e.g., if the PUCCH resource 910 includes the multiple sets of PRBs), the UE 120 may transmit the UCI using the multiple beams 962a, 962b respectively in the multiple sets of PRBs. That is, a respective beam of the multiple beams may be used for transmission in a respective set of PRBs of the multiple sets of PRBs. As shown in FIG. 9H, and by reference number 970, the UCI may be rate matched across the multiple sets of PRBs. In other words, the UCI may be rate matched to the single set of PRBs in a manner irrespective of whether the UE 120 is using a single beam or multiple beam, as described above. Here, the UE 120 may transmit a first part of the UCI (shown as UCI sequence part 964a) in the first set of PRBs of the multiple sets of PRBs on a first beam 962a and a second part of the UCI (shown as UCI sequence part 964b) in the second set of PRBs of the multiple sets of PRBs on a second beam 964b. As shown in FIG. 9I, and by reference number 975, the UE 120 may transmit a first repetition of the UCI (e.g., of UCI sequence 964) in the first set of PRBs of the multiple sets of PRBs on a first beam 962a and a second repetition of the UCI (e.g., of UCI sequence 964) in the second set of PRBs of the multiple sets of PRBs on a second beam 962b. Here, to avoid different rate matching, the quantity of PRBs in the first set of PRBs and the second set of PRBs may be the same (e.g., the UE 120 may expect the quantity of PRBs in the sets of PRBs to be equal).

As indicated above, FIGS. 9A-9I are provided as an example. Other examples may differ from what is described with respect to FIGS. 9A-9I.

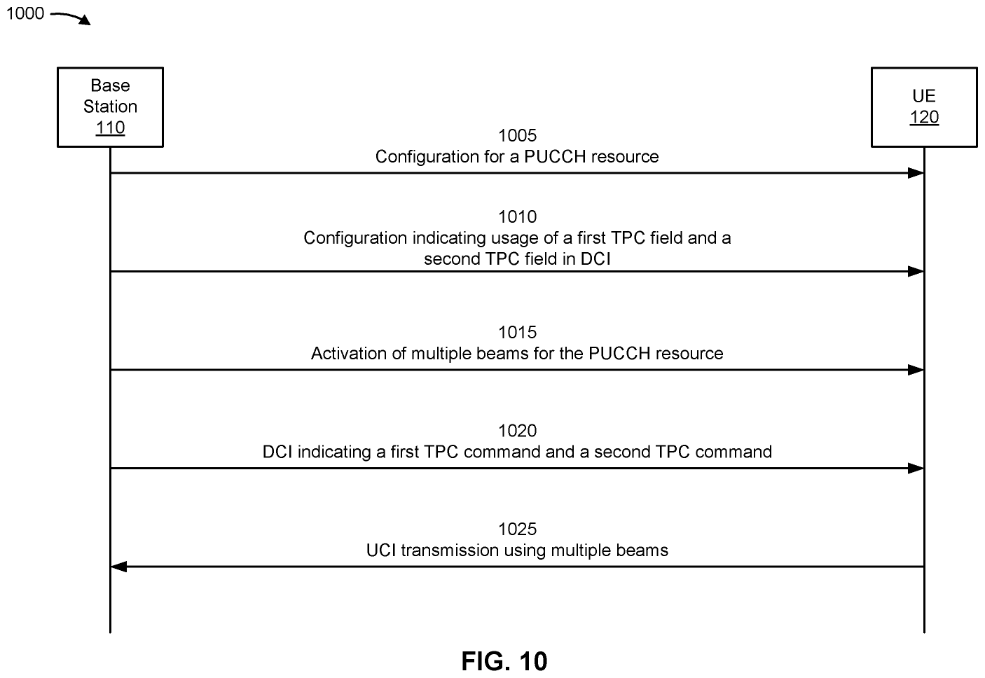

FIG. 10 is a diagram illustrating an example 1000 associated with PUCCH transmission with simultaneous beams, in accordance with the present disclosure. As shown in FIG. 10, a base station 110 and a UE 120 may communicate with one another. In some aspects, the UE 120 may communicate with the base station 110 via a first TRP and/or a second TRP (not shown).

As shown by reference number 1005, the base station 110 may transmit, and the UE 120 may receive, a configuration for a PUCCH resource, in a similar manner as described above. For example, the configuration may indicate whether simultaneous beams are enabled for the PUCCH resource (e.g., using the simutaneousbeams parameter), indicate a first starting PRB for a first set of PRBs of the PUCCH resource (e.g., in the firstbeamPRB parameter), and/or indicate a second starting PRB for a second set of PRBs of the PUCCH resource (e.g., in the secondbeamPRB parameter).

As shown by reference number 1010, the base station 110 may transmit, and the UE 120 may receive, a configuration indicating usage of a first TPC field and a second TPC field in DCI (e.g., DCI format 1_1 or 1_2), in a similar manner as described above. For example, the configuration may indicate that the second TPC field is enabled for DCI (e.g., DCI format 1_1 or 1_2). In some aspects, the base station 110 may transmit the configurations described in connection with reference numbers 1005 and 1010 in a same message (e.g., in a same RRC message). In some aspects, the base station 110 may transmit the configurations described in connection with reference numbers 1005 and 1010 in different messages (e.g., in different RRC messages).

As shown by reference number 1015, the base station 110 may transmit, and the UE 120 may receive, an activation of the multiple beams for the PUCCH resource, in a similar manner as described above. For example, the base station 110 may transmit a MAC-CE that activates multiple spatial relations and/or the base station 110 may transmit DCI that indicates multiple TCI states (e.g., a pair of joint TCI states or a pair of uplink TCI states). The multiple spatial relations and/or the multiple TCI states may be determined by the base station 110 based at least in part on beam reporting by the UE 120.

As shown by reference number 1020, the base station 110 may transmit, and the UE 120 may receive, DCI that indicates a first TPC command in a first TPC field and a second TPC command in a second TPC field, in a similar manner as described above. The DCI may schedule a PUCCH in the PUCCH resource. In some aspects, the DCI described in connection with reference numbers 1015 and 1020 may be the same DCI (e.g., may be transmitted in the same PDCCH). In some aspects, the DCI described in connection with reference numbers 1015 and 1020 may be different DCIs (e.g., may be transmitted in different PDCCHs). In some aspects, the base station 110 may schedule the PUCCH in the PUCCH resource using signaling other than DCI (e.g., the base station 110 may schedule the PUCCH in the PUCCH resource via RRC signaling, a MAC-CE, or the like).

As shown by reference number 1025, the UE 120 may transmit, and the base station 110 may receive (e.g., via a first TRP and a second TRP), the UCI using the multiple beams in a common time domain resource, in a similar manner as described above. For example, the UE 120 may transmit the UCI using the multiple beams in the single set of PRBs of the PUCCH resource (e.g., if the PUCCH resource includes only the single set of PRBs). As another example, the UE 120 may transmit the UCI using the multiple beams respectively in the multiple sets of PRBs (e.g., if the PUCCH resource include the multiple sets of PRBs). In some aspects, the multiple beams may correspond to the spatial relations activated by the MAC-CE and/or the TCI states indicated by the DCI, as described in connection with reference number 1015.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with PUCCH transmission with simultaneous beams.

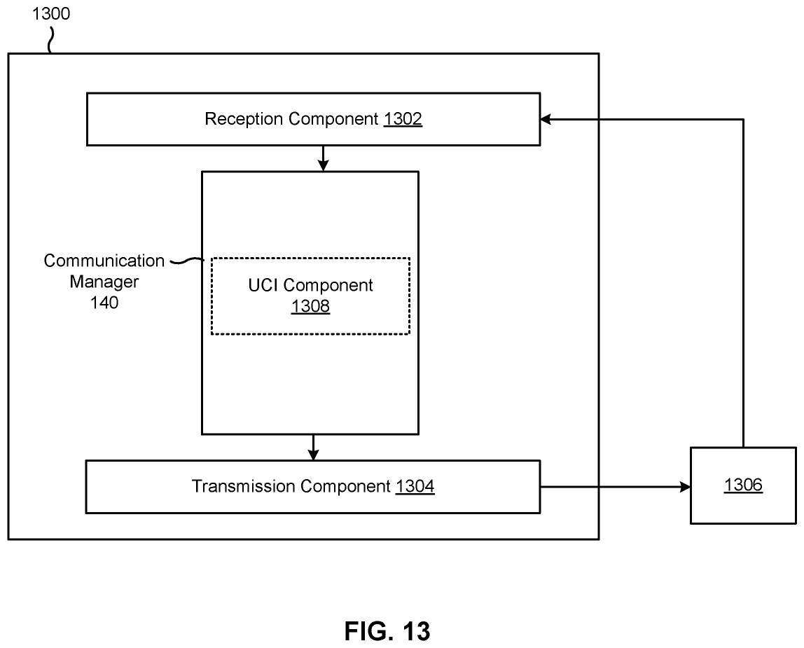

As shown in FIG. 11, in some aspects, process 1100 may include receiving a configuration for a PUCCH resource for a transmission using multiple beams in a common time domain resource, the PUCCH resource including a single set of PRBs or multiple sets of PRBs (block 1110). For example, the UE (e.g., using communication manager 140 and/or reception component 1302, depicted in FIG. 13) may receive a configuration for a PUCCH resource for a transmission using multiple beams in a common time domain resource, as described above. In some aspects, the PUCCH resource may include a single set of PRBs or multiple sets of PRBs.

In some aspects, process 1100 may include receiving another configuration indicating usage of a first TPC field and a second TPC field in DCI (block 1112). For example, the UE (e.g., using communication manager 140 and/or reception component 1302, depicted in FIG. 13) may receive another configuration indicating usage of a first TPC field and a second TPC field in DCI.

In some aspects, process 1100 may include receiving an activation of the multiple beams for the PUCCH resource (block 1114). For example, the UE (e.g., using communication manager 140 and/or reception component 1302, depicted in FIG. 13) may receive an activation of the multiple beams for the PUCCH resource, as described above. In some aspects, the activation is of multiple spatial relations in a MAC-CE or of multiple TCI states in DCI.

In some aspects, process 1100 may include receiving DCI (block 1116). For example, the UE (e.g., using communication manager 140 and/or reception component 1302, depicted in FIG. 13) may receive the DCI. In some aspects, the DCI may indicate a first TPC command and a second TPC command, where the first TPC command is for a first set of PRBs of the multiple sets of PRBs and the second TPC command is for a second set of PRBs of the multiple sets of PRBs. In some aspects, the DCI may indicate a single TPC command, where the single TPC command is split between a first set of PRBs of the multiple sets of PRBs and a second set of PRBs of the multiple sets of PRBs.

As further shown in FIG. 11, in some aspects, process 1100 may include transmitting UCI using the multiple beams in the single set of PRBs of the PUCCH resource or using the multiple beams in a respective set of PRBs of the multiple sets of PRBs of the PUCCH resource (block 1120). For example, the UE (e.g., using communication manager 140 and/or transmission component 1304, depicted in FIG. 13) may transmit UCI using the multiple beams in the single set of PRBs of the PUCCH resource or using the multiple beams respectively in the multiple sets of PRBs of the PUCCH resource, as described above.

Process 1100 may include additional aspects, such as any single aspect or any combination of aspects described below and/or in connection with one or more other processes described elsewhere herein.

In a first aspect, process 1100 includes receiving an activation of the multiple beams for the PUCCH resource, where the activation is of multiple spatial relations in a MAC-CE or of multiple TCI states in downlink control information.

In a second aspect, alone or in combination with the first aspect, the UCI is rate matched across the multiple sets of PRBs.

In a third aspect, alone or in combination with one or more of the first and second aspects, a first repetition of the UCI is transmitted in a first set of PRBs of the multiple sets of PRBs and a second repetition of the UCI is transmitted in a second set of PRBs of the multiple sets of PRBs.

In a fourth aspect, alone or in combination with one or more of the first through third aspects, the configuration indicates a first starting PRB for a first set of PRBs of the multiple sets of PRBs and a second starting PRB for a second set of PRBs of the multiple sets of PRBs.

In a fifth aspect, alone or in combination with one or more of the first through fourth aspects, the configuration indicates a PUCCH format associated with a single PRB in a set of PRBs.

In a sixth aspect, alone or in combination with one or more of the first through fifth aspects, the configuration indicates a PUCCH format associated with multiple PRBs in a set of PRBs.

In a seventh aspect, alone or in combination with one or more of the first through sixth aspects, a quantity of PRBs for the PUCCH resource is split between the first set of PRBs and the second set of PRBs.

In an eighth aspect, alone or in combination with one or more of the first through seventh aspects, a quantity of PRBs for the PUCCH resource is used for the first set of PRBs and the quantity of PRBs for the PUCCH resource is used for the second set of PRBs.

In a ninth aspect, alone or in combination with one or more of the first through eighth aspects, a quantity of PRBs for the PUCCH resource is an indicated quantity of PRBs for the PUCCH resource.

In a tenth aspect, alone or in combination with one or more of the first through ninth aspects, a quantity of PRBs for the PUCCH resource is an actual quantity of PRBs used for the PUCCH resource after rate matching of the UCI to the PUCCH resource.

In an eleventh aspect, alone or in combination with one or more of the first through tenth aspects, process 1100 includes receiving another configuration indicating usage of a first TPC field and a second TPC field in downlink control information.

In a twelfth aspect, alone or in combination with one or more of the first through eleventh aspects, process 1100 includes receiving downlink control information that indicates a first TPC command and a second TPC command, where the first TPC command is for a first set of PRBs of the multiple sets of PRBs and the second TPC command is for a second set of PRBs of the multiple sets of PRBs.

In a thirteenth aspect, alone or in combination with one or more of the first through twelfth aspects, process 1100 includes receiving downlink control information that indicates a single TPC command, where the single TPC command is split between a first set of PRBs of the multiple sets of PRBs and a second set of PRBs of the multiple sets of PRBs.

In a fourteenth aspect, alone or in combination with one or more of the first through thirteenth aspects, a first transform precoding is used for a first set of PRBs of the multiple sets of PRBs and a second transform precoding is used for a second set of PRBs of the multiple sets of PRBs.

In a fifteenth aspect, alone or in combination with one or more of the first through fourteenth aspects, a single transform precoding is used for a first set of PRBs of the multiple sets of PRBs and a second set of PRBs of the multiple sets of PRBs.

In a sixteenth aspect, alone or in combination with one or more of the first through fifteenth aspects, the UCI is transmitted using the multiple beams in the single set of PRBs in a single frequency network manner.

In a seventeenth aspect, alone or in combination with one or more of the first through sixteenth aspects, the UCI is rate matched to the single set of PRBs in connection with a first beam of the multiple beams and a second beam of the multiple beams.

In an eighteenth aspect, alone or in combination with one or more of the first through seventeenth aspects, the UCI is transmitted using the multiple beams in the single set of PRBs using a single antenna port.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with PUCCH transmission with simultaneous beams.

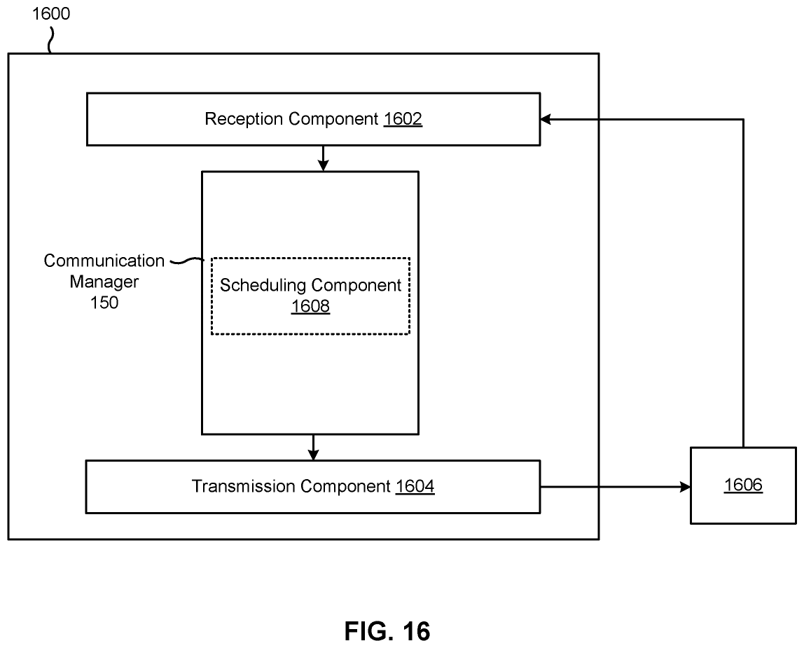

As shown in FIG. 12, in some aspects, process 1200 may include transmitting a configuration for a PUCCH resource for a transmission using multiple beams in a common time domain resource, the PUCCH resource including a single set of PRBs or multiple sets of PRBs (block 1210). For example, the base station (e.g., using communication manager 150 and/or transmission component 1604, depicted in FIG. 16) may transmit a configuration for a PUCCH resource for a transmission using multiple beams in a common time domain resource, as described above. In some aspects, the PUCCH resource including a single set of PRBs or multiple sets of PRBs.

In some aspects, process 1200 may include transmitting another configuration indicating usage of a first TPC field and a second TPC field in DCI (block 1212). For example, the base station (e.g., using communication manager 150 and/or transmission component 1604, depicted in FIG. 16) may transmit another configuration indicating usage of a first TPC field and a second TPC field in DCI.

In some aspects, process 1200 may include transmitting an activation of the multiple beams for the PUCCH resource (block 1214). For example, the base station (e.g., using communication manager 150 and/or transmission component 1604, depicted in FIG. 16) may transmit an activation of the multiple beams for the PUCCH resource, as described above. In some aspects, the activation is of multiple spatial relations in a MAC-CE or of multiple TCI states in DCI.

In some aspects, process 1200 may include transmitting DCI (block 1216). For example, the base station (e.g., using communication manager 150 and/or transmission component 1604, depicted in FIG. 16) may transmit the DCI. In some aspects, the DCI may indicate a first TPC command and a second TPC command, where the first TPC command is for a first set of PRBs of the multiple sets of PRBs and the second TPC command is for a second set of PRBs of the multiple sets of PRBs. In some aspects, the DCI may indicate a single TPC command, where the single TPC command is split between a first set of PRBs of the multiple sets of PRBs and a second set of PRBs of the multiple sets of PRBs.

As further shown in FIG. 12, in some aspects, process 1200 may include receiving UCI using the multiple beams in the single set of PRBs of the PUCCH resource or using the multiple beams in a respective set of PRBs of the multiple sets of PRBs of the PUCCH resource (block 1220). For example, the base station (e.g., using communication manager 150 and/or reception component 1602, depicted in FIG. 16) may receive UCI using the multiple beams in the single set of PRBs of the PUCCH resource or using the multiple beams respectively in the multiple sets of PRBs of the PUCCH resource, as described above.

Process 1200 may include additional aspects, such as any single aspect or any combination of aspects described below and/or in connection with one or more other processes described elsewhere herein.

In a first aspect, process 1200 includes transmitting an activation of the multiple beams for the PUCCH resource, where the activation is of multiple spatial relations in a MAC-CE or of multiple TCI states in downlink control information.

In a second aspect, alone or in combination with the first aspect, the UCI is rate matched across the multiple sets of PRBs.

In a third aspect, alone or in combination with one or more of the first and second aspects, a first repetition of the UCI is received in a first set of PRBs of the multiple sets of PRBs and a second repetition of the UCI is received in a second set of PRBs of the multiple sets of PRBs.

In a fourth aspect, alone or in combination with one or more of the first through third aspects, the configuration indicates a first starting PRB for a first set of PRBs of the multiple sets of PRBs and a second starting PRB for a second set of PRBs of the multiple sets of PRBs.

In a fifth aspect, alone or in combination with one or more of the first through fourth aspects, the configuration indicates a PUCCH format associated with a single PRB in a set of PRBs.

In a sixth aspect, alone or in combination with one or more of the first through fifth aspects, the configuration indicates a PUCCH format associated with multiple PRBs in a set of PRBs.

In a seventh aspect, alone or in combination with one or more of the first through sixth aspects, a quantity of PRBs for the PUCCH resource is split between the first set of PRBs and the second set of PRBs.

In an eighth aspect, alone or in combination with one or more of the first through seventh aspects, a quantity of PRBs for the PUCCH resource is used for the first set of PRBs and the quantity of PRBs for the PUCCH resource is used for the second set of PRBs.

In a ninth aspect, alone or in combination with one or more of the first through eighth aspects, a quantity of PRBs for the PUCCH resource is an indicated quantity of PRBs for the PUCCH resource.

In a tenth aspect, alone or in combination with one or more of the first through ninth aspects, a quantity of PRBs for the PUCCH resource is an actual quantity of PRBs used for the PUCCH resource after rate matching of the UCI to the PUCCH resource.

In an eleventh aspect, alone or in combination with one or more of the first through tenth aspects, process 1200 includes transmitting another configuration indicating usage of a first TPC field and a second TPC field in downlink control information.

In a twelfth aspect, alone or in combination with one or more of the first through eleventh aspects, process 1200 includes transmitting downlink control information that indicates a first TPC command and a second TPC command, where the first TPC command is for a first set of PRBs of the multiple sets of PRBs and the second TPC command is for a second set of PRBs of the multiple sets of PRBs.

In a thirteenth aspect, alone or in combination with one or more of the first through twelfth aspects, process 1200 includes transmitting downlink control information that indicates a single TPC command, where the single TPC command is split between a first set of PRBs of the multiple sets of PRBs and a second set of PRBs of the multiple sets of PRBs.

In a fourteenth aspect, alone or in combination with one or more of the first through thirteenth aspects, a first transform precoding is used for a first set of PRBs of the multiple sets of PRBs and a second transform precoding is used for a second set of PRBs of the multiple sets of PRBs.

In a fifteenth aspect, alone or in combination with one or more of the first through fourteenth aspects, a single transform precoding is used for a first set of PRBs of the multiple sets of PRBs and a second set of PRBs of the multiple sets of PRBs.

In a sixteenth aspect, alone or in combination with one or more of the first through fifteenth aspects, the UCI is received using the multiple beams in the single set of PRBs in a single frequency network manner.

In a seventeenth aspect, alone or in combination with one or more of the first through sixteenth aspects, the UCI is rate matched to the single set of PRBs in connection with a first beam of the multiple beams and a second beam of the multiple beams.

In an eighteenth aspect, alone or in combination with one or more of the first through seventeenth aspects, the UCI is received using the multiple beams in the single set of PRBs in accordance with the transmission using a single antenna port.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a UCI component 1308, among other examples.

In some aspects, the apparatus 1300 may be configured to perform one or more operations described herein in connection with FIGS. 9A-9I and 10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive a configuration for a PUCCH resource for a transmission using multiple beams in a common time domain resource. In some aspects, the PUCCH resource may include a single set of PRBs or multiple sets of PRBs. The transmission component 1304 may transmit UCI using the multiple beams in the single set of PRBs of the PUCCH resource or using the multiple beams respectively in the multiple sets of PRBs of the PUCCH resource. The UCI component 1308 may determine the UCI that is transmitted. The UCI component 1308 may generate the UCI sequence for the UCI that is transmitted.

The reception component 1302 may receive another configuration indicating usage of a first TPC field and a second TPC field in DCI. The reception component 1302 may receive an activation of the multiple beams for the PUCCH resource. In some aspects, the activation is of multiple spatial relations in a MAC-CE or of multiple TCI states in DCI. The reception component 1302 may receive DCI that indicates a first TPC command and a second TPC command. In some aspects, the first TPC command is for a first set of PRBs of the multiple sets of PRBs and the second TPC command is for a second set of PRBs of the multiple sets of PRBs. The reception component 1302 may receive DCI that indicates a single TPC command. In some aspects, the single TPC command is split between a first set of PRBs of the multiple sets of PRBs and a second set of PRBs of the multiple sets of PRBs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

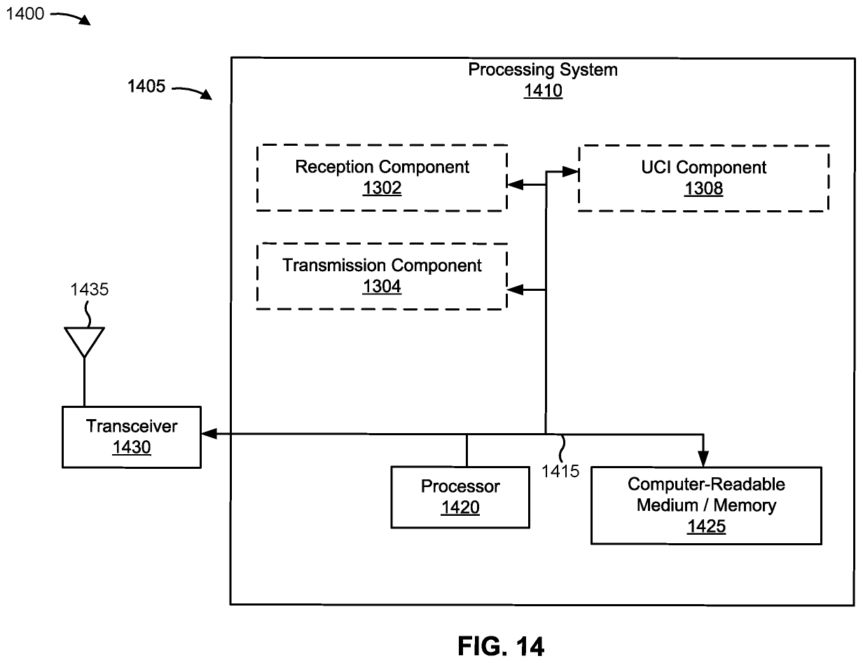

FIG. 14 is a diagram illustrating an example 1400 of a hardware implementation for an apparatus 1405 employing a processing system 1410. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the receive processor 258, and/or the controller/processor 280. In some aspects, the apparatus 1405 for wireless communication includes means for receiving a configuration for a PUCCH resource for a transmission using multiple beams in a common time domain resource, the PUCCH resource including a single set of PRBs or multiple sets of PRBs; and/or means for transmitting UCI using the multiple beams in the single set of PRBs of the PUCCH resource or using the multiple beams respectively in the multiple sets of PRBs of the PUCCH resource. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 14 is provided as an example. Other examples may differ from what is described in connection with FIG. 14.

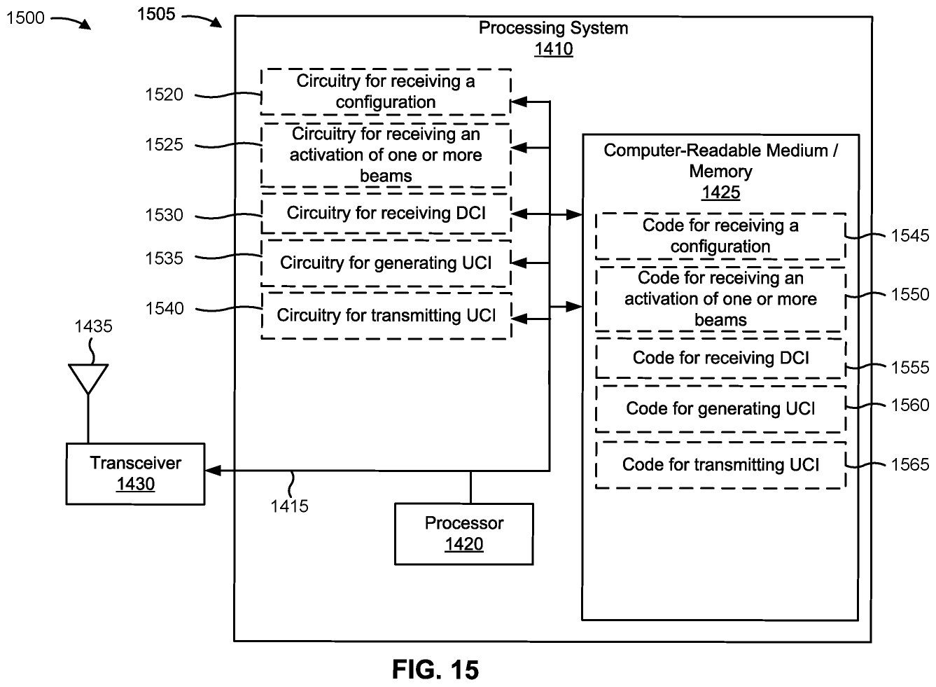

FIG. 15 is a diagram illustrating an example 1500 of an implementation of code and circuitry for an apparatus 1505, in accordance with the present disclosure. The apparatus 1505 may be a UE.

As shown in FIG. 15, the apparatus 1505 may include circuitry for receiving a configuration (circuitry 1520). For example, the circuitry 1520 may provide means for receiving a configuration for a PUCCH resource for a transmission using multiple beams in a common time domain resource, the PUCCH resource including a single set of PRBs or multiple sets of PRBs. As another example, the circuitry 1520 may provide means for receiving another configuration indicating usage of a first TPC field and a second TPC field in DCI.

As shown in FIG. 15, the apparatus 1505 may include circuitry for receiving an activation of one or more beams (circuitry 1525). For example, the circuitry 1525 may provide means for receiving an activation of the multiple beams for the PUCCH resource.

As shown in FIG. 15, the apparatus 1505 may include circuitry for receiving DCI (circuitry 1530). For example, the circuitry 1530 may provide means for receiving DCI that indicates a first TPC command and a second TPC command. As another example, the circuitry 1530 may provide means for receiving DCI that indicates a single TPC command.

As shown in FIG. 15, the apparatus 1505 may include circuitry for generating UCI (circuitry 1535). For example, the circuitry 1535 may provide means for generating UCI (e.g., a UCI sequence) that is to be transmitted in the PUCCH resource.

As shown in FIG. 15, the apparatus 1505 may include circuitry for transmitting UCI (circuitry 1540). For example, the circuitry 1540 may provide means for transmitting the UCI using the multiple beams in the single set of PRBs of the PUCCH resource or using the multiple beams respectively in the multiple sets of PRBs of the PUCCH resource.

The circuitry 1520, 1525, 1530, 1535, and/or 1540 may include one or more components of the UE described above in connection with FIG. 2, such as transmit processor 264, TX MIMO processor 266, modem 254, MIMO detector 256, receive processor 258, antenna 252, controller/processor 280, and/or memory 282.

As shown in FIG. 15, the apparatus 1505 may include, stored in computer-readable medium 1425, code for receiving a configuration (code 1545). For example, the code 1545, when executed by the processor 1420, may cause the apparatus 1505 to receive a configuration for a PUCCH resource for a transmission using multiple beams in a common time domain resource, the PUCCH resource including a single set of PRBs or multiple sets of PRBs. As another example, the code 1545, when executed by the processor 1420, may cause the apparatus 1505 to receive another configuration indicating usage of a first TPC field and a second TPC field in DCI.

As shown in FIG. 15, the apparatus 1505 may include, stored in computer-readable medium 1425, code for receiving an activation of one or more beams (code 1550). For example, the code 1550, when executed by the processor 1420, may cause the apparatus 1505 to receive an activation of the multiple beams for the PUCCH resource.

As shown in FIG. 15, the apparatus 1505 may include, stored in computer-readable medium 1425, code for receiving DCI (code 1555). For example, the code 1555, when executed by the processor 1420, may cause the apparatus 1505 to receive DCI that indicates a first TPC command and a second TPC command. As another example, the code 1555, when executed by the processor 1420, may cause the apparatus 1505 to receive DCI that indicates a single TPC command.

As shown in FIG. 15, the apparatus 1505 may include, stored in computer-readable medium 1425, code for generating UCI (code 1560). For example, the code 1560, when executed by the processor 1420, may cause the apparatus 1505 to generate UCI (e.g., a UCI sequence) that is to be transmitted in the PUCCH resource.

As shown in FIG. 15, the apparatus 1505 may include, stored in computer-readable medium 1425, code for transmitting UCI (code 1565). For example, the code 1565, when executed by the processor 1420, may cause the apparatus 1505 to transmit the UCI using the multiple beams in the single set of PRBs of the PUCCH resource or using the multiple beams respectively in the multiple sets of PRBs of the PUCCH resource.

FIG. 15 is provided as an example. Other examples may differ from what is described in connection with FIG. 15.

FIG. 16 is a diagram of an example apparatus 1600 for wireless communication. The apparatus 1600 may be a base station and/or a TRP, or a base station and/or a TRP may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. The communication manager 150 may include a scheduling component 1608, among other examples.

In some aspects, the apparatus 1600 may be configured to perform one or more operations described herein in connection with FIGS. 9A-9I and 10. Additionally, or alternatively, the apparatus 1600 may be configured to perform one or more processes described herein, such as process 1200 of FIG. 12, or a combination thereof. In some aspects, the apparatus 1600 and/or one or more components shown in FIG. 16 may include one or more components of the base station described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the base station described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the base station described in connection with FIG. 2. In some aspects, the transmission component 1604 may be co-located with the reception component 1602 in a transceiver.

The transmission component 1604 may transmit a configuration for a PUCCH resource for a transmission using multiple beams in a common time domain resource, the PUCCH resource including a single set of PRBs or multiple sets of PRBs. The reception component 1602 may receive UCI using the multiple beams in the single set of PRBs of the PUCCH resource or using the multiple beams respectively in the multiple sets of PRBs of the PUCCH resource. The scheduling component 1608 may schedule transmission of the UCI in the PUCCH resource.

The transmission component 1604 may transmit another configuration indicating usage of a first TPC field and a second TPC field in DCI. The transmission component 1604 may transmit an activation of the multiple beams for the PUCCH resource. In some aspects, the activation is of multiple spatial relations in a MAC-CE or of multiple TCI states in DCI. The transmission component 1604 may transmit DCI that indicates a first TPC command and a second TPC command. In some aspects, the first TPC command is for a first set of PRBs of the multiple sets of PRBs and the second TPC command is for a second set of PRBs of the multiple sets of PRBs. The transmission component 1604 may transmit DCI that indicates a single TPC command. In some aspects, the single TPC command is split between a first set of PRBs of the multiple sets of PRBs and a second set of PRBs of the multiple sets of PRBs.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

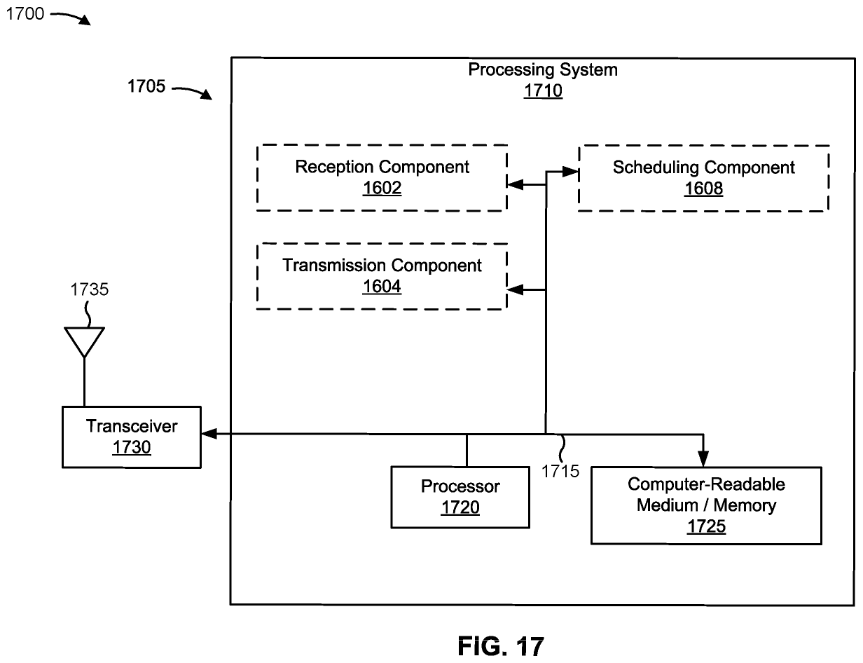

FIG. 17 is a diagram illustrating an example 1700 of a hardware implementation for an apparatus 1705 employing a processing system 1710. The apparatus 1705 may be a base station and/or a TRP.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the receive processor 238, and/or the controller/processor 240. In some aspects, the apparatus 1705 for wireless communication includes means for transmitting a configuration for a PUCCH resource for a transmission using multiple beams in a common time domain resource, the PUCCH resource including a single set of PRBs or multiple sets of PRBs; and/or means for receiving UCI using the multiple beams in the single set of PRBs of the PUCCH resource or using the multiple beams respectively in the multiple sets of PRBs of the PUCCH resource. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

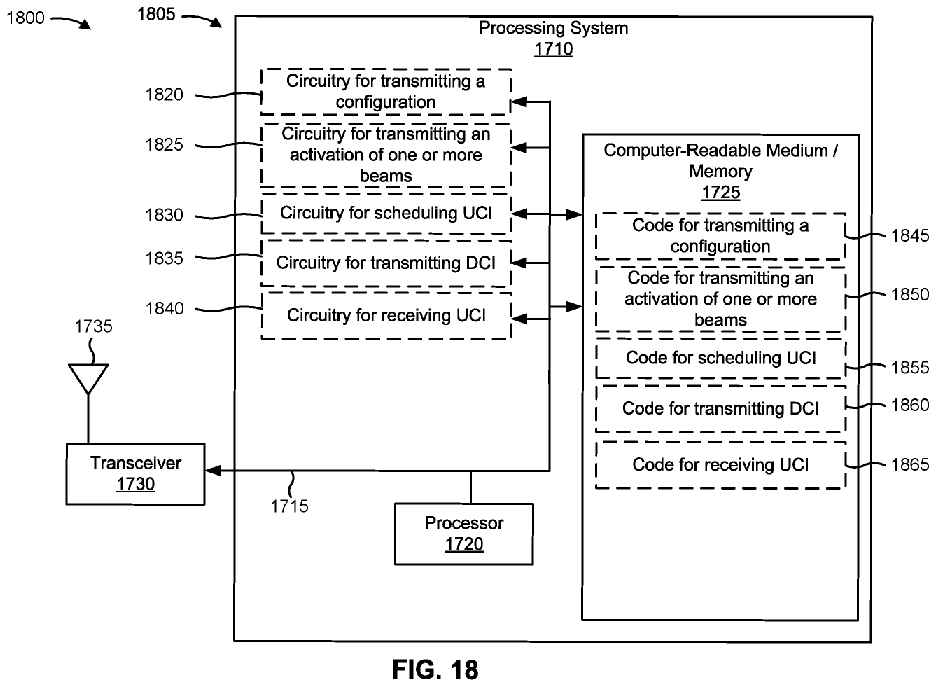

FIG. 18 is a diagram illustrating an example 1800 of an implementation of code and circuitry for an apparatus 1805, in accordance with the present disclosure. The apparatus 1805 may be a base station and/or a TRP.

As shown in FIG. 18, the apparatus 1805 may include circuitry for transmitting a configuration (circuitry 1820). For example, the circuitry 1820 may provide means for transmitting a configuration for a PUCCH resource for a transmission using multiple beams in a common time domain resource, the PUCCH resource including a single set of PRBs or multiple sets of PRBs. As another example, the circuitry 1820 may provide means for transmitting another configuration indicating usage of a first TPC field and a second TPC field in DCI.

As shown in FIG. 18, the apparatus 1805 may include circuitry for transmitting an activation of one or more beams (circuitry 1825). For example, the circuitry 1825 may provide means for transmitting an activation of the multiple beams for the PUCCH resource.

As shown in FIG. 18, the apparatus 1805 may include circuitry for scheduling UCI (circuitry 1830). For example, the circuitry 1830 may provide means for scheduling UCI in the PUCCH resource.

As shown in FIG. 18, the apparatus 1805 may include circuitry for transmitting DCI (circuitry 1835). For example, the circuitry 1835 may provide means for transmitting DCI that indicates a first TPC command and a second TPC command. As another example, the circuitry 1835 may provide means for transmitting DCI that indicates a single TPC command.

As shown in FIG. 18, the apparatus 1805 may include circuitry for receiving UCI (circuitry 1840). For example, the circuitry 1840 may provide means for receiving the UCI using the multiple beams in the single set of PRBs of the PUCCH resource or using the multiple beams respectively in the multiple sets of PRBs of the PUCCH resource.

The circuitry 1820, 1825, 1830, 1835, and/or 1840 may include one or more components of the base station described above in connection with FIG. 2, such as transmit processor 220, TX MIMO processor 230, modem 232, antenna 234, MIMO detector 236, receive processor 238, controller/processor 240, memory 242, and/scheduler 246.

As shown in FIG. 18, the apparatus 1805 may include, stored in computer-readable medium 1725, code for transmitting a configuration (code 1845). For example, the code 1845, when executed by the processor 1720, may cause the apparatus 1805 to transmit a configuration for a PUCCH resource for a transmission using multiple beams in a common time domain resource, the PUCCH resource including a single set of PRBs or multiple sets of PRBs. As another example, the code 1845, when executed by the processor 1720, may cause the apparatus 1805 to transmit another configuration indicating usage of a first TPC field and a second TPC field in DCI.

As shown in FIG. 18, the apparatus 1805 may include, stored in computer-readable medium 1725, code for transmitting an activation of one or more beams (code 1850). For example, the code 1850, when executed by the processor 1720, may cause the apparatus 1805 to transmit an activation of the multiple beams for the PUCCH resource.

As shown in FIG. 18, the apparatus 1805 may include, stored in computer-readable medium 1725, code for scheduling UCI (code 1855). For example, the code 1855, when executed by the processor 1720, may cause the apparatus 1805 to schedule the UCI in the PUCCH resource.

As shown in FIG. 18, the apparatus 1805 may include, stored in computer-readable medium 1725, code for transmitting DCI (code 1860). For example, the code 1860, when executed by the processor 1720, may cause the apparatus 1805 to transmit DCI that indicates a first TPC command and a second TPC command. As another example, the code 1860, when executed by the processor 1720, may cause the apparatus 1805 to transmit DCI that indicates a single TPC command.

As shown in FIG. 18, the apparatus 1805 may include, stored in computer-readable medium 1725, code for receiving UCI (code 1865). For example, the code 1865, when executed by the processor 1720, may cause the apparatus 1805 to receive the UCI using the multiple beams in the single set of PRBs of the PUCCH resource or using the multiple beams respectively in the multiple sets of PRBs of the PUCCH resource.

FIG. 18 is provided as an example. Other examples may differ from what is described in connection with FIG. 18.

The following provides an overview of some Aspects of the present disclosure:

Aspect 1: A method of wireless communication performed by an apparatus of a user equipment (UE), comprising: receiving a configuration for a physical uplink control channel (PUCCH) resource for a transmission that uses multiple beams in a same time domain resource, the PUCCH resource including multiple sets of physical resource blocks (PRBs); and transmitting uplink control information (UCI) using the multiple beams in a respective set of PRBs of the multiple sets of PRBs of the PUCCH resource.

Aspect 2: The method of Aspect 1, further comprising: receiving an activation of the multiple beams for the PUCCH resource, wherein the activation is of multiple spatial relations in a medium access control control element (MAC-CE) or of multiple transmission configuration indicator (TCI) states in downlink control information.

Aspect 3: The method of any of Aspects 1-2, wherein the UCI is rate matched across the multiple sets of PRBs.

Aspect 4: The method of any of Aspects 1-2, wherein a first repetition of the UCI is transmitted in a first set of PRBs of the multiple sets of PRBs and a second repetition of the UCI is transmitted in a second set of PRBs of the multiple sets of PRBs.

Aspect 5: The method of any of Aspects 1-4, wherein the configuration indicates a first starting PRB for a first set of PRBs of the multiple sets of PRBs and a second starting PRB for a second set of PRBs of the multiple sets of PRBs.

Aspect 6: The method of Aspect 5, wherein the configuration indicates a PUCCH format associated with a single PRB in a set of PRBs.

Aspect 7: The method of Aspect 5, wherein the configuration indicates a PUCCH format associated with multiple PRBs in a set of PRBs.

Aspect 8: The method of Aspect 7, wherein a quantity of PRBs for the PUCCH resource is split between the first set of PRBs and the second set of PRBs.

Aspect 9: The method of Aspect 7, wherein a quantity of PRBs for the PUCCH resource is used for the first set of PRBs and the quantity of PRBs for the PUCCH resource is used for the second set of PRBs.

Aspect 10: The method of any of Aspects 7-9, wherein a quantity of PRBs for the PUCCH resource is an indicated quantity of PRBs for the PUCCH resource.

Aspect 11: The method of any of Aspects 7-9, wherein a quantity of PRBs for the PUCCH resource is an actual quantity of PRBs used for the PUCCH resource after rate matching of the UCI to the PUCCH resource.

Aspect 12: The method of any of Aspects 1-11, further comprising: receiving another configuration indicating usage of a first transmit power control (TPC) field and a second TPC field in downlink control information.

Aspect 13: The method of any of Aspects 1-12, further comprising: receiving downlink control information that indicates a first transmit power control (TPC) command and a second TPC command, wherein the first TPC command is for a first set of PRBs of the multiple sets of PRBs and the second TPC command is for a second set of PRBs of the multiple sets of PRBs.

Aspect 14: The method of any of Aspects 1-12, further comprising: receiving downlink control information that indicates a single transmit power control (TPC) command, wherein the single TPC command is split between a first set of PRBs of the multiple sets of PRBs and a second set of PRBs of the multiple sets of PRBs.

Aspect 15: The method of any of Aspects 1-14, wherein a first transform precoding is used for a first set of PRBs of the multiple sets of PRBs and a second transform precoding is used for a second set of PRBs of the multiple sets of PRBs.

Aspect 16: The method of any of Aspects 1-14, wherein a single transform precoding is used for a first set of PRBs of the multiple sets of PRBs and a second set of PRBs of the multiple sets of PRBs.

Aspect 17: A method of wireless communication performed by an apparatus of a base station, comprising: transmitting a configuration for a physical uplink control channel (PUCCH) resource for a transmission that uses multiple beams in a same time domain resource, the PUCCH resource including multiple sets of physical resource blocks (PRBs); and receiving uplink control information (UCI) using the multiple beams in a respective set of PRBs of the multiple sets of PRBs of the PUCCH resource.

Aspect 18: The method of Aspect 17, further comprising: transmitting an activation of the multiple beams for the PUCCH resource, wherein the activation is of multiple spatial relations in a medium access control control element (MAC-CE) or of multiple transmission configuration indicator (TCI) states in downlink control information.

Aspect 19: The method of any of Aspects 17-18, wherein the UCI is rate matched across the multiple sets of PRBs.

Aspect 20: The method of any of Aspects 17-18, wherein a first repetition of the UCI is received in a first set of PRBs of the multiple sets of PRBs and a second repetition of the UCI is received in a second set of PRBs of the multiple sets of PRBs.

Aspect 21: The method of any of Aspects 17-20, wherein the configuration indicates a first starting PRB for a first set of PRBs of the multiple sets of PRBs and a second starting PRB for a second set of PRBs of the multiple sets of PRBs.

Aspect 22: The method of Aspect 21, wherein the configuration indicates a PUCCH format associated with a single PRB in a set of PRBs.

Aspect 23: The method of Aspect 21, wherein the configuration indicates a PUCCH format associated with multiple PRBs in a set of PRBs.

Aspect 24: The method of Aspect 23, wherein a quantity of PRBs for the PUCCH resource is split between the first set of PRBs and the second set of PRBs.

Aspect 25: The method of Aspect 23, wherein a quantity of PRBs for the PUCCH resource is used for the first set of PRBs and the quantity of PRBs for the PUCCH resource is used for the second set of PRBs.

Aspect 26: The method of any of Aspects 23-25, wherein a quantity of PRBs for the PUCCH resource is an indicated quantity of PRBs for the PUCCH resource.

Aspect 27: The method of any of Aspects 23-25, wherein a quantity of PRBs for the PUCCH resource is an actual quantity of PRBs used for the PUCCH resource after rate matching of the UCI to the PUCCH resource.

Aspect 28: The method of any of Aspects 17-27, further comprising: transmitting another configuration indicating usage of a first transmit power control (TPC) field and a second TPC field in downlink control information.

Aspect 29: The method of any of Aspects 17-28, further comprising: transmitting downlink control information that indicates a first transmit power control (TPC) command and a second TPC command, wherein the first TPC command is for a first set of PRBs of the multiple sets of PRBs and the second TPC command is for a second set of PRBs of the multiple sets of PRBs.

Aspect 30: The method of any of Aspects 17-28, further comprising: transmitting downlink control information that indicates a single transmit power control (TPC) command, wherein the single TPC command is split between a first set of PRBs of the multiple sets of PRBs and a second set of PRBs of the multiple sets of PRBs.

Aspect 31: The method of any of Aspects 17-30, wherein a first transform precoding is used for a first set of PRBs of the multiple sets of PRBs and a second transform precoding is used for a second set of PRBs of the multiple sets of PRBs.

Aspect 32: The method of any of Aspects 17-30, wherein a single transform precoding is used for a first set of PRBs of the multiple sets of PRBs and a second set of PRBs of the multiple sets of PRBs.

Aspect 33: A method of wireless communication performed by an apparatus of a user equipment (UE), comprising: receiving a configuration for a physical uplink control channel (PUCCH) resource for a transmission that uses multiple beams in a same time domain resource, the PUCCH resource including a single set of physical resource blocks (PRBs); and transmitting uplink control information (UCI) using the multiple beams in the single set of PRBs of the PUCCH resource.

Aspect 34: The method of Aspect 33, further comprising: receiving an activation of the multiple beams for the PUCCH resource, wherein the activation is of multiple spatial relations in a medium access control control element (MAC-CE) or of multiple transmission configuration indicator (TCI) states in downlink control information.

Aspect 35: The method of any of Aspects 33-34, wherein the UCI is transmitted using the multiple beams in the single set of PRBs in a single frequency network manner.

Aspect 36: The method of any of Aspects 33-35, wherein the UCI is rate matched to the single set of PRBs in connection with a first beam of the multiple beams and a second beam of the multiple beams.

Aspect 37: The method of any of Aspects 33-36, wherein the UCI is transmitted using the multiple beams in the single set of PRBs using a single antenna port.

Aspect 38: A method of wireless communication performed by an apparatus of a base station, comprising: transmitting a configuration for a physical uplink control channel (PUCCH) resource for a transmission that uses multiple beams in a same time domain resource, the PUCCH resource including a single set of physical resource blocks (PRBs); and receiving uplink control information (UCI) using the multiple beams in the single set of PRBs of the PUCCH resource.

Aspect 39: The method of Aspect 38, further comprising: transmitting an activation of the multiple beams for the PUCCH resource, wherein the activation is of multiple spatial relations in a medium access control control element (MAC-CE) or of multiple transmission configuration indicator (TCI) states in downlink control information.

Aspect 40: The method of any of Aspects 38-39, wherein the UCI is received using the multiple beams in the single set of PRBs in a single frequency network manner.

Aspect 41: The method of any of Aspects 38-40, wherein the UCI is rate matched to the single set of PRBs in connection with a first beam of the multiple beams and a second beam of the multiple beams.

Aspect 42: The method of any of Aspects 38-41, wherein the UCI is received using the multiple beams in the single set of PRBs in accordance with the transmission using a single antenna port.

Aspect 43: An apparatus for wireless communication at a device, comprising a processor; memory coupled with the processor; and instructions stored in the memory and executable by the processor to cause the apparatus to perform the method of one or more of Aspects 1-16.

Aspect 44: A device for wireless communication, comprising a memory and one or more processors coupled to the memory, the one or more processors configured to perform the method of one or more of Aspects 1-16.

Aspect 45: An apparatus for wireless communication, comprising at least one means for performing the method of one or more of Aspects 1-16.

Aspect 46: A non-transitory computer-readable medium storing code for wireless communication, the code comprising instructions executable by a processor to perform the method of one or more of Aspects 1-16.

Aspect 47: A non-transitory computer-readable medium storing a set of instructions for wireless communication, the set of instructions comprising one or more instructions that, when executed by one or more processors of a device, cause the device to perform the method of one or more of Aspects 1-16.

Aspect 48: An apparatus for wireless communication at a device, comprising a processor; memory coupled with the processor; and instructions stored in the memory and executable by the processor to cause the apparatus to perform the method of one or more of Aspects 17-32.

Aspect 49: A device for wireless communication, comprising a memory and one or more processors coupled to the memory, the one or more processors configured to perform the method of one or more of Aspects 17-32.

Aspect 50: An apparatus for wireless communication, comprising at least one means for performing the method of one or more of Aspects 17-32.

Aspect 51: A non-transitory computer-readable medium storing code for wireless communication, the code comprising instructions executable by a processor to perform the method of one or more of Aspects 17-32.

Aspect 52: A non-transitory computer-readable medium storing a set of instructions for wireless communication, the set of instructions comprising one or more instructions that, when executed by one or more processors of a device, cause the device to perform the method of one or more of Aspects 17-32.

Aspect 53: An apparatus for wireless communication at a device, comprising a processor; memory coupled with the processor; and instructions stored in the memory and executable by the processor to cause the apparatus to perform the method of one or more of Aspects 33-37.

Aspect 54: A device for wireless communication, comprising a memory and one or more processors coupled to the memory, the one or more processors configured to perform the method of one or more of Aspects 33-37.

Aspect 55: An apparatus for wireless communication, comprising at least one means for performing the method of one or more of Aspects 33-37.

Aspect 56: A non-transitory computer-readable medium storing code for wireless communication, the code comprising instructions executable by a processor to perform the method of one or more of Aspects 33-37.

Aspect 57: A non-transitory computer-readable medium storing a set of instructions for wireless communication, the set of instructions comprising one or more instructions that, when executed by one or more processors of a device, cause the device to perform the method of one or more of Aspects 33-37.

Aspect 58: An apparatus for wireless communication at a device, comprising a processor; memory coupled with the processor; and instructions stored in the memory and executable by the processor to cause the apparatus to perform the method of one or more of Aspects 38-42.

Aspect 59: A device for wireless communication, comprising a memory and one or more processors coupled to the memory, the one or more processors configured to perform the method of one or more of Aspects 38-42.

Aspect 60: An apparatus for wireless communication, comprising at least one means for performing the method of one or more of Aspects 38-42.

Aspect 61: A non-transitory computer-readable medium storing code for wireless communication, the code comprising instructions executable by a processor to perform the method of one or more of Aspects 38-42.

Aspect 62: A non-transitory computer-readable medium storing a set of instructions for wireless communication, the set of instructions comprising one or more instructions that, when executed by one or more processors of a device, cause the device to perform the method of one or more of Aspects 38-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, the memory and the one or more processors configured to:
receive a configuration for a physical uplink control channel (PUCCH) resource for a transmission that uses multiple beams in a same time domain resource, the PUCCH resource including multiple sets of physical resource blocks (PRBs); and
transmit uplink control information (UCI) using the multiple beams in a respective set of PRBs of the multiple sets of PRBs of the PUCCH resource.

2. The apparatus of claim 1, wherein the UCI is rate matched across the multiple sets of PRBs.

3. The apparatus of claim 1, wherein a first repetition of the UCI is transmitted in a first set of PRBs of the multiple sets of PRBs and a second repetition of the UCI is transmitted in a second set of PRBs of the multiple sets of PRBs.

4. The apparatus of claim 1, wherein the configuration indicates a first starting PRB for a first set of PRBs of the multiple sets of PRBs and a second starting PRB for a second set of PRBs of the multiple sets of PRBs.

5. The apparatus of claim 1, wherein a quantity of PRBs for the PUCCH resource is split between a first set of PRBs of the multiple sets of PRBs and a second set of PRBs of the multiple sets of PRBs.

6. The apparatus of claim 1, wherein a quantity of PRBs for the PUCCH resource is used for a first set of PRBs of the multiple sets of PRBs and the quantity of PRBs for the PUCCH resource is used for a second set of PRBs of the multiple sets of PRBs.

7. The apparatus of claim 1, wherein the memory and the one or more processors are further configured to:
receive another configuration indicating usage of a first transmit power control (TPC) field and a second TPC field in downlink control information.

8. The apparatus of claim 1, wherein the memory and the one or more processors are further configured to:
receive downlink control information that indicates a first transmit power control (TPC) command and a second TPC command,
wherein the first TPC command is for a first set of PRBs of the multiple sets of PRBs and the second TPC command is for a second set of PRBs of the multiple sets of PRBs.

9. The apparatus of claim 1, wherein the memory and the one or more processors are further configured to:
receive downlink control information that indicates a single transmit power control (TPC) command,
wherein the single TPC command is split between a first set of PRBs of the multiple sets of PRBs and a second set of PRBs of the multiple sets of PRBs.

10. The apparatus of claim 1, wherein a first transform precoding is used for a first set of PRBs of the multiple sets of PRBs and a second transform precoding is used for a second set of PRBs of the multiple sets of PRBs.

11. The apparatus of claim 1, wherein a single transform precoding is used for a first set of PRBs of the multiple sets of PRBs and a second set of PRBs of the multiple sets of PRBs.

12. An apparatus for wireless communication at a base station, comprising:
a memory; and
one or more processors, coupled to the memory, the memory and the one or more processors configured to:
transmit a configuration for a physical uplink control channel (PUCCH) resource for a transmission that uses multiple beams in a same time domain resource, the PUCCH resource including multiple sets of physical resource blocks (PRBs); and
receive uplink control information (UCI) using the multiple beams in a respective set of PRBs of the multiple sets of PRBs of the PUCCH resource.

13. The apparatus of claim 12, wherein the UCI is rate matched across the multiple sets of PRBs.

14. The apparatus of claim 12, wherein a first repetition of the UCI is received in a first set of PRBs of the multiple sets of PRBs and a second repetition of the UCI is received in a second set of PRBs of the multiple sets of PRBs.

15. The apparatus of claim 12, wherein the configuration indicates a first starting PRB for a first set of PRBs of the multiple sets of PRBs and a second starting PRB for a second set of PRBs of the multiple sets of PRBs.

16. The apparatus of claim 12, wherein a quantity of PRBs for the PUCCH resource is split between a first set of PRBs of the multiple sets of PRBs and a second set of PRBs of the multiple sets of PRBs.

17. The apparatus of claim 12, wherein a quantity of PRBs for the PUCCH resource is used for a first set of PRBs of the multiple sets of PRBs and the quantity of PRBs for the PUCCH resource is used for a second set of PRBs of the multiple sets of PRBs.

18. The apparatus of claim 12, wherein the memory and the one or more processors are further configured to:
transmit another configuration indicating usage of a first transmit power control (TPC) field and a second TPC field in downlink control information.

19. The apparatus of claim 12, wherein the memory and the one or more processors are further configured to:
transmit downlink control information that indicates a first transmit power control (TPC) command and a second TPC command,
wherein the first TPC command is for a first set of PRBs of the multiple sets of PRBs and the second TPC command is for a second set of PRBs of the multiple sets of PRBs.

20. The apparatus of claim 12, wherein the memory and the one or more processors are further configured to:
transmit downlink control information that indicates a single transmit power control (TPC) command,
wherein the single TPC command is split between a first set of PRBs of the multiple sets of PRBs and a second set of PRBs of the multiple sets of PRBs.

21. The apparatus of claim 12, wherein a first transform precoding is used for a first set of PRBs of the multiple sets of PRBs and a second transform precoding is used for a second set of PRBs of the multiple sets of PRBs.

22. The apparatus of claim 12, wherein a single transform precoding is used for a first set of PRBs of the multiple sets of PRBs and a second set of PRBs of the multiple sets of PRBs.

23. An apparatus for wireless communication at a user equipment (UE), comprising:
a memory; and
one or more processors, coupled to the memory, the memory and the one or more processors configured to:
receive a configuration for a physical uplink control channel (PUCCH) resource for a transmission that uses multiple beams in a same time domain resource, the PUCCH resource including a single set of physical resource blocks (PRBs); and
transmit uplink control information (UCI) using the multiple beams in the single set of PRBs of the PUCCH resource.

24. The apparatus of claim 23, wherein the UCI is transmitted using the multiple beams in the single set of PRBs in a single frequency network manner.

25. The apparatus of claim 23, wherein the UCI is rate matched to the single set of PRBs in connection with a first beam of the multiple beams and a second beam of the multiple beams.

26. The apparatus of claim 23, wherein the UCI is transmitted using the multiple beams in the single set of PRBs using a single antenna port.

27. An apparatus for wireless communication at a base station, comprising:
a memory; and
one or more processors, coupled to the memory, the memory and the one or more processors configured to:
transmit a configuration for a physical uplink control channel (PUCCH) resource for a transmission that uses multiple beams in a same time domain resource, the PUCCH resource including a single set of physical resource blocks (PRBs); and
receive uplink control information (UCI) using the multiple beams in the single set of PRBs of the PUCCH resource.

28. The apparatus of claim 27, wherein the UCI is received using the multiple beams in the single set of PRBs in a single frequency network manner.

29. The apparatus of claim 27, wherein the UCI is rate matched to the single set of PRBs in connection with a first beam of the multiple beams and a second beam of the multiple beams.

30. The apparatus of claim 27, wherein the UCI is received using the multiple beams in the single set of PRBs in accordance with the transmission using a single antenna port.
